(19) United States
(12) Patent Application Publication
(10) Pub. No.: US 2025/0219816 A1
(43) Pub. Date: Jul. 3, 2025

(54) METHOD AND APPARATUS TO REDUCE REJECTION RATE OF INTEGERS GENERATED BY A RANDOM NUMBER GENERATOR

(71) Applicant: Intel Corporation, Santa Clara, CA (US)

(72) Inventors: Anupam GOLDER, Hillsboro, OR (US); Raghavan KUMAR, Hillsboro, OR (US); Sachin TANEJA, Hillsboro, OR (US); Sanu K. MATHEW, Portland, OR (US); Christopher B. WILKERSON, Vancouver, WA (US); Anuj DUBEY, Hillsboro, OR (US); Vikram B. SURESH, Portland, OR (US)

(21) Appl. No.: 18/396,995

(22) Filed: Dec. 27, 2023

(51) Int. Cl. H04L 9/08; H04L 9/00

(52) U.S. Cl. CPC H04L 9/0869; H04L 9/008

(57) ABSTRACT

An on-die key generator includes a pseudo-random number generator (PRNG) and a sampler. The pseudo-random number generator generates integers modulo a power-of-two number, based on an initial seed. The sampler uniformly maps the integers generated by the random number generator (RNG) from the number space of 0−(2ⁿ−1) to the ciphertext modulus space of 0−(q−1) by randomly mapping the integers generated by the pseudo-random number generator that are greater than or equal to q to a value inside the range [0, q−1] using additional random bits.

### STATEMENT REGARDING FEDERALLY SPONSORED RESEARCH

This invention was made with Government support under contract number HR0011-21-3-0003 awarded by the Department of Defense. The Government has certain rights in this invention.

### BACKGROUND

Fully Homomorphic Encryption (FHE) is a form of encryption that allows computations to be performed on encrypted data without first having to decrypt it. The computations are performed on polynomials. The degree of a polynomial is the highest of the degrees of the polynomial's individual terms with non-zero coefficients. The degree of a term is the sum of the exponents of the variables in the term. The degree of the polynomial is the highest exponent in the polynomial.

For example, the polynomial 5x⁴+3x-10 has three terms, one variable x and three coefficients (number that is being multiplied by a variable). The first term has a degree of 4, the second term has a degree of 1 and the third term has a degree of 0. The polynomial has a degree of 4 (the highest exponent of the terms in the polynomial).

Fully Homomorphic Encryption (FHE) enables computation on encrypted data, or ciphertext, rather than plaintext, or unencrypted data, keeping data protected at all times. FHE uses lattice-based cryptography, which presents complex mathematical challenges to would-be attackers.

FHE standards support a wide range of polynomials, with the degree of the polynomial ranging from 1024 (1K) up to 128K and where each coefficient in the polynomial can range from 32 bits up to 2K bits dependent on the degree of the polynomial.

### BRIEF DESCRIPTION OF DRAWINGS

Various examples in accordance with the present disclosure will be described with reference to the drawings, in which:

FIG. 1 illustrates an example of an on-die key generator that includes a pseudo-random number generator (PRNG) and a sampler;

FIG. 2 illustrates an example system;

FIG. 3 illustrates an example of system that includes a fully homomorphic encryption accelerator including key generator circuitry to generate fully homomorphic encryption accelerator (FHE) public keys;

FIG. 4 is an example of integers modulo a power-of-two number in the number space of 0−(2ⁿ−1) generated by a pseudo-random number generator, where n is 5 (total number of distinct integers generated by the pseudo-random number generator is 2⁵ (32 (0 to 31))), the modulus q is 17 and bound (the largest integer in the range [q, 2ⁿ−1] to be mapped, where n=[log₂ q]) is 29;

FIG. 5 is a block diagram of a sampler that reduces the rejection rate of the raw random number generator values generated by a pseudo-random number generator by randomly mapping the raw RNG values received from the pseudo-random number generator that are greater than or equal to q to a value inside the range [0,q−1] using additional random bits;

FIG. 6 is a flowgraph illustrating a method performed by the random number map circuitry in the random bin sampler that receives random_in[31:0], bound[31:0], bin_select[3:0], and bin_size[27:0] as inputs, and maps from integers outside the range [0,q−1] to integers inside the range [0,q−1];

FIG. 7 is a flowgraph illustrating a method performed by the valid circuitry in the random bin sampler that receives random_in[31:0], bound[31:0], bin_select[3:0], and nbin_outside[3:0] as inputs, and outputs a valid signal;

FIG. 8 illustrates an example of key generator circuitry in the scratch pad memory units shown in FIG. 2;

FIG. 9 is a block diagram of one key generator circuitry in the KeyGen module that includes 16 key generator circuitry in the FHE accelerator;

FIG. 10 is a block diagram of SPM units in the FHE accelerator;

FIG. 11 is a flowgraph of a method performed in the FHE accelerator to generate fully-homomorphic encryption relinearization public keys;

FIG. 12A illustrates examples of an instruction format;

FIG. 12B illustrates a Key Generation seed (KG_seed) instruction to load a seed stored in scratch pad memory from the scratch pad memory to key generation registers and to load a prime modulus q, bin size, bound and nbin_outside (the number of bins in the range [q, bound−1]) from the scratch pad memory to be used by a random bin sampler in key generator circuitry;

FIG. 12C illustrates a Key Generation start stop (KG_start_stop) instruction to toggle the state of the Key Generation operation between start and stop and stop and start;

FIG. 12D illustrates a Key Generation load (KG_load) instruction to load the key generated by the key generation instruction from the buffer into the compute engine;

FIG. 13 illustrates an example computing system;

FIG. 14 illustrates a block diagram of an example SoC that may have one or more processor cores and an integrated memory controller;

FIG. 15(A) is a block diagram illustrating both an example in-order pipeline and an example register renaming, out-of-order issue/execution pipeline according to examples;

FIG. 15(B) is a block diagram illustrating both an example in-order architecture core and an example register renaming, out-of-order issue/execution architecture core to be included in a processor according to examples;

FIG. 16 illustrates examples of execution unit(s) circuitry;

FIG. 17 is a block diagram of a register architecture according to some examples;

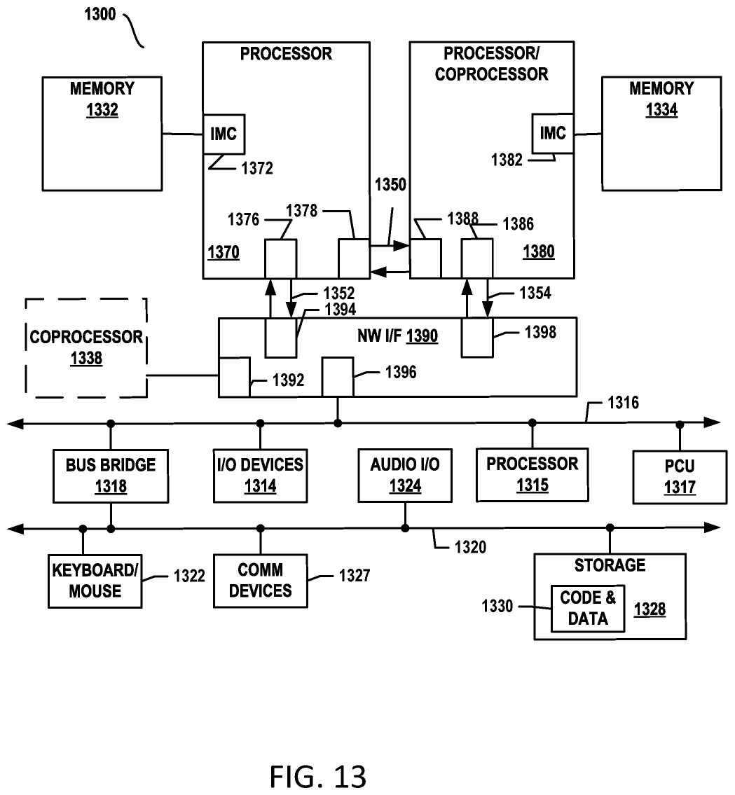

FIG. 13 illustrates examples of an addressing information field;

FIG. 19 illustrates examples of a first prefix;

FIGS. 20(A)-(D) illustrate examples of how the R, X, and B fields of the first prefix in FIG. 19 are used;

FIGS. 21(A)-(B) illustrate examples of a second prefix;

FIG. 22 illustrates examples of a third prefix; and

FIG. 23 is a block diagram illustrating the use of a software instruction converter to convert binary instructions in a source instruction set architecture to binary instructions in a target instruction set architecture according to examples.

### DETAILED DESCRIPTION

Fully-Homomorphic-Encryption (FHE) ciphertext is represented as a pair of polynomials C₀ and C₁ (2-term ciphertext [C₀, C₁]). FHE multiplication on a 2-term ciphertext ([C₀,C₁] and a 2-term ciphertext [D₀,D₁]) results in a 3-term ciphertext ([E₀, E₁, E₂]). FHE Relinearization remaps the 3-term ciphertext ([E₀, E₁, E₂]) back to a 2-term ciphertext ([F₀, F₁]), which decrypts to the same value as the 3-term ciphertext ([E₀, E₁, E₂]). For a polynomial with degree of 16K, each polynomial is 1 Mega Bytes. Hence, back-to-back FHE multiplications result in FHE ciphertexts of increasing sizes.

One of the polynomials in the pair of polynomials C₀ and C₁ representing the Fully-Homomorphic-Encryption (FHE) ciphertext is a public key A. A key generator in software is used to generate the public key A from a seed. For example, a software Application Program Interface (API) can be used to generate the public key A using a key generator implemented in a library (for example, OpenFHE, SEAL (Software-Optimized Encryption Algorithm)). The public key A is loaded into a System-on-Chip (SoC) that includes a FHE accelerator to perform a FHE relinearization operation. The FHE accelerator includes High Bandwidth Memory (HBM), scratch pad memory and a compute engine. The public key A used to perform the FHE relinearization operation is stored in the HBM and the scratch pad memory in the FHE accelerator. The public key A uses a significant portion of the HBM and the scratch pad memory. For example, a relinearization key can consume between tens to hundreds of Mega Bytes (MB)s dependent on the polynomial size. The public key A consumes HBM bandwidth and scratch pad memory bandwidth. For example, about 90% of the data moved from the HBM to the scratch pad memory during FHE relinearization operations is related to key-switching-material.

HBM bandwidth and scratch pad memory bandwidth used during FHE relinearization is reduced by including an on-die key generator in the SoC to generate the FHE public keys from a seed that is input to the SoC. The seed is used by the on-die key generator circuit to generate FHE relinearization public keys locally within the scratch pad memory units in the SoC.

Lattice-Based Cryptography (LBC) schemes (for example, Fully Homomorphic Encryption (FHE) schemes) typically require sampling from uniform distribution of integers modulo q∈Z (denoted as U(Z_{q}), where Z_{q}={0, 1, . . . , q−1}), which is used to generate a random mask polynomial. To perform multiplication between two ciphertext polynomials, q is chosen to be a modulus such that number theoretic transform (NTT)-based fast polynomial multiplication can be performed to improve the asymptotic computational complexity from O(N²) to O(N log₂N), where N is typically a power-of-two number. This imposes a restriction on the value of q, which must satisfy the condition q ≡1 (mod N) for NTT. A polynomial ring modulo a 2N-th cyclotomic polynomial, X^{N}+1 is used, which requires a negacyclic (also known as negatively wrapped) convolution (i.e., polynomial multiplication), which may impose an additional constraint on the modulus such that q ≡1 (mod 2N). In some cases (e.g., CRYSTALS-KYBER), this additional constraint can be removed by modifying the NTT-based fast polynomial multiplication. For FHE schemes, different choices of q need to be coprime to each other to enable residue number system (RNS)-based arithmetic. Co-prime numbers are pairs of numbers that do not have any common factor other than 1. Typically, q is chosen to be a prime number.

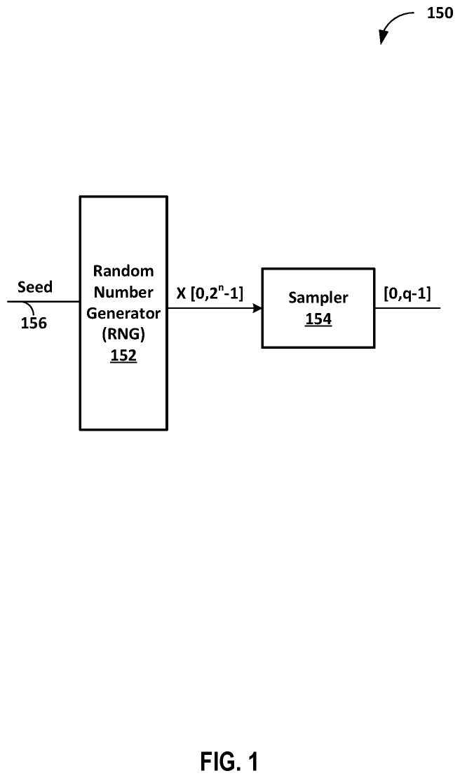

FIG. 1 illustrates an example of an on-die key generator 150 that includes a pseudo-random number generator (PRNG) 152 and a sampler 154. The pseudo-random number generator 152 generates integers modulo a power-of-two number, for example, 2³² or 2⁶⁴ (referred to as raw random number generator (RNG) values) based on an initial seed 156. The sampler 154 uniformly maps the raw RNG values (X) from the number space of 0−(2ⁿ−1) (for example, for 0−(2³²−1) (n=32) or 0−(2⁶⁴−1) (n=64)) to the ciphertext modulus space of 0−(q−1) by rejecting any raw RNG values (X) generated by the pseudo-random number generator 152 that are greater than or equal to q, and accepting raw RNG values (X) generated by the pseudo-random number generator 152 that are less than q. A value X is valid if it is in the ciphertext modulus space of 0−(q−1). For example, if q is 13 and the number space is 0−(2⁴−1) (values between 0 and 15), values 0-12 are valid and values 13-15 are not valid.

The rejection rate (r)=(1−q/2ⁿ), where q is the modulus; n is the bit width of the modulus (log₂ q); and 2ⁿ is the next power-of-two number greater than q. The average time to generate a given number of valid samples less than q is inversely proportional to the rejection rate. The rejection rate can be as high as about 50%. Also, the average latency is proportional to the number of samples to be generated.

The rejection rate in the sampler is reduced by randomly mapping raw RNG values generated by the pseudo-random number generator that are greater than or equal to q to a value less than q using additional random bits.

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

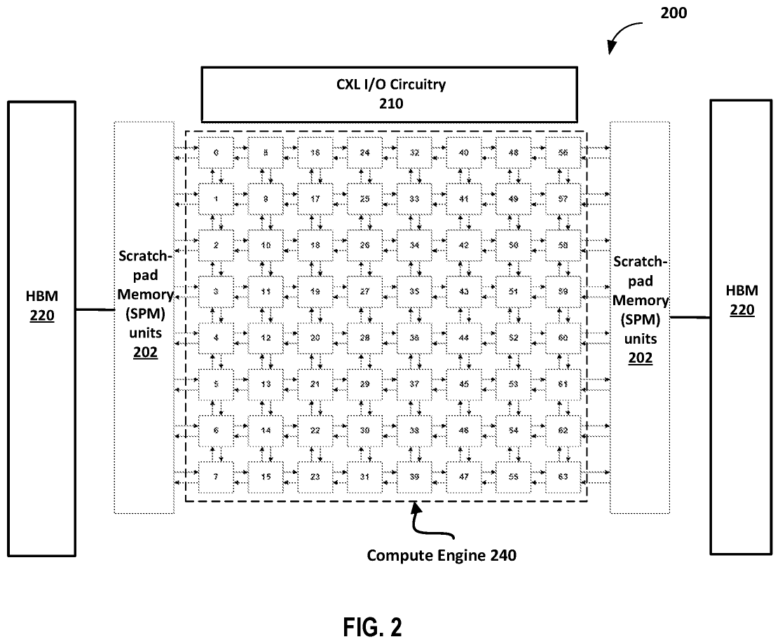

FIG. 2 illustrates an example system 200. In some examples, system 200 can be included in and/or operate within a compute platform. The compute platform, for example, could be located in a data center included in, for example, cloud computing infrastructure, examples are not limited to system 200 included in a compute platform located in a data center. As shown in FIG. 2, system 200 includes compute express link (CXL) input/output (I/O) circuitry 210, high bandwidth memory (HBM) 220, scratch pad memory units 202 and tile array in a compute engine 240 (also referred to as a tile array).

In some examples, system 200 can be configured as a parallel processing device or accelerator to perform FHE relinearization operations/computations for accelerating FHE workloads. For these examples, CXL I/O circuitry 210 can be configured to couple with one or more host central processing units (CPUs—not shown) to receive instructions and/or data via circuitry designed to operate in compliance with one or more CXL specifications published by the CXL Consortium to included, but not limited to, CXL Specification, Rev. 2.0, Ver. 1.0, published Oct. 26, 2020, or CXL Specification, Rev. 3.0, Ver. 1.0, published Aug. 1, 2022. Also, CXL I/O circuitry 210 can be configured to enable one or more host CPUs to obtain data associated with execution of accelerated FHE workloads by compute elements included in interconnected tiles of the compute engine 240. For example, data (for example, ciphertext or processed ciphertext) may be moved to or moved from HBM 220 and CXL I/O circuitry 210 can facilitate the data movement into or out of HBM 220 as part of execution of accelerated FHE workloads. Also, scratch pad memory in scratch pad memory units 202 can be a type of memory (for example, register files) that can be proportionately allocated to tiles included in tile array in compute engine 240 to facilitate execution of the accelerated FHE workloads and to perform FHE relinearization operations. Scratch pad memory is used to store coefficients used by the plurality of compute elements to perform operations on polynomials.

In some examples, as described in more detail below, tile array in compute engine 240 can be arranged in an 8×8 tile configuration as shown in FIG. 2 that includes tiles 0 to 63. For these examples, each tile can include, but is not limited to, 128 compute elements (not shown in FIG. 2). As shown in FIG. 2, tiles 0 to 63 can be interconnected via point-to-point connections via a 2-dimensional (2D) mesh interconnect-based architecture. The 2D mesh enables communications between adjacent tiles using single-hop links. Tiles included in tile array in compute engine 240 can be augmented with router circuitry that can route data received via inputs or sent via outputs across all 4 directions.

Examples are not limited to use of CXL I/O circuitry such as CXL I/O circuitry 210 to facilitate receiving instructions and/or data or providing executed results associated with FHE workloads. Other types of I/O circuitry and/or additional circuitry to receive instructions and/or data or provide executed results are contemplated.

Examples are not limited to HBM such as HBM 220 for receiving data to be processed (memory to store the data to be processed) or to store information associated with instructions to execute an FHE workload or execution results of the FHE workload. Other types of volatile memory or non-volatile memory are contemplated for use in system 200. Other types of volatile memory can include, but are not limited to, Dynamic RAM (DRAM), DDR synchronous dynamic RAM (DDR SDRAM), GDDR, static random-access memory (SRAM), thyristor RAM (T-RAM) or zero-capacitor RAM (Z-RAM). Non-volatile types of memory can include byte or block addressable types of non-volatile memory such as, but not limited to, multi-threshold level NAND flash memory, NOR flash memory, single or multi-level phase change memory (PCM), resistive memory, nanowire memory, ferroelectric transistor random access memory (FeTRAM), anti-ferroelectric memory, resistive memory including a metal oxide base, an oxygen vacancy base and a conductive bridge random access memory (CB-RAM), a spintronic magnetic junction memory, a magnetic tunneling junction (MTJ) memory, a domain wall (DW) and spin orbit transfer (SOT) memory, a thyristor based memory, a magnetoresistive random access memory (MRAM) that incorporates memristor technology, spin transfer torque MRAM (STT-MRAM), or a combination of any of the above.

According to some examples, system 200 can be included in a system-on-a-chip (SoC). SoC is a term often used to describe a device or system having a compute element and associated circuitry (e.g., I/O circuitry, butterfly circuits, power delivery circuitry, memory controller circuitry, memory circuitry, etc.) integrated monolithically into a single integrated circuit (“IC”) die, or chip. For example, a device, computing platform or computing system could have one or more compute elements (for example, butterfly circuits) and associated circuitry (for example, I/O circuitry, power delivery circuitry, memory controller circuitry, memory circuitry, etc.) arranged in a disaggregated collection of discrete dies, tiles and/or chiplets (e.g., one or more discrete compute die arranged adjacent to one or more other die such as memory die, I/O die, etc.). The compute elements to support operations on polynomials. In such disaggregated devices and systems, the various dies, tiles and/or chiplets could be physically and electrically coupled together by a package structure including, for example, various packaging substrates, interposers, interconnect bridges and the like. Also, these disaggregated devices can be referred to as a system-on-a-package (SoP).

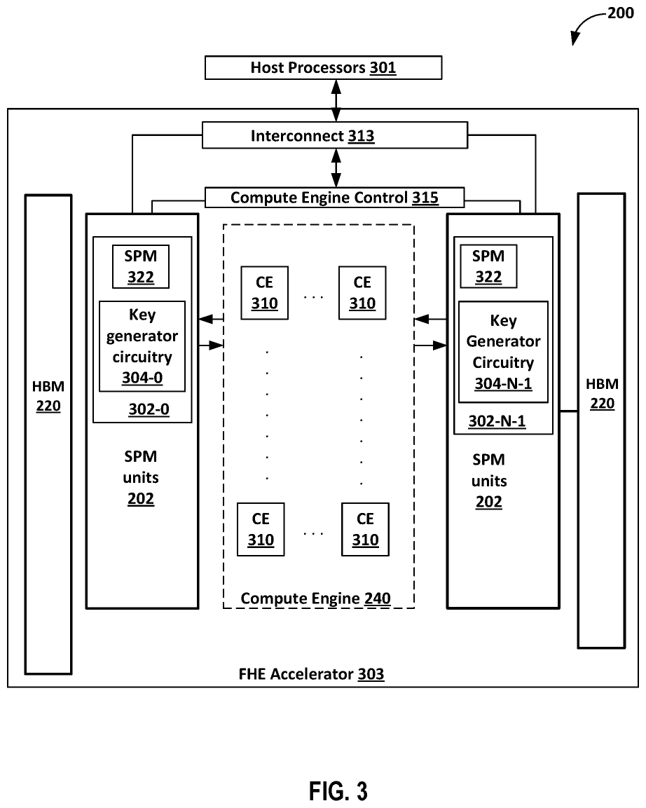

FIG. 3 illustrates an example of system 200 that includes a fully homomorphic encryption accelerator 303 including key generator circuitry 304 to generate Fully Homomorphic Encryption (FHE) public keys. As shown, the FHE accelerator 303 couples to one or more host processors 301 such as one or more central processing unit (CPU) cores via one or more interconnects 313.

The one or more interconnects 313 are coupled to scratch pad memory (SPM) units 202 which handle load/stores of data and provide data for execution by the compute engine 240 comprising a tile array that includes tiles 0 to 63 as shown in FIG. 2. In some examples, tiles 0 to 63 are coupled to scratch pad memory units 202, the interconnect 313, and/or a compute engine control block 315. Tiles in the compute engine 240 include compute elements 310. In an embodiment, each tile can include, but is not limited to, 128 compute elements 310. Scratch pad memory 302 in scratch pad memory units 202 can be a type of memory (for example, register files).

The scratch pad memory units 202 are coupled to high bandwidth memory (HBM) 220 which stores a larger amount of data. In some examples, the data is distributed across HBM 220 and banks of scratch pad memory in scratch pad memory units 202. In some examples, HBM 220 is external to the FHE accelerator 303. In some examples, some HBM 220 is external to the FHE accelerator 303 and some HBM 220 is internal to the FHE accelerator 303.

The scratch pad memory units 202 include N scratch pad memory units 302-0, . . . 302-N−1. In an embodiment N is 16. In other embodiments, N can be 4-32. Each scratch pad memory unit 302-0 includes key generator circuitry 304 and scratch pad memory 322.

In some examples, a compute engine control block 315 dispatches instructions and handles synchronization of data from the HBM 220 and scratch pad memory units 202 for the compute engine 240. In some examples, memory loads and stores are tracked in the compute engine control block 315 and dispatched across the scratch pad memory units 202 for coordinated data fetch. These loads and stores are handled locally in the scratch pad memory units 202 and written into the scratch pad memory 322 in scratch pad memory units 202 and/or HBM 220. In some examples, the compute engine control block 315 includes an instruction decoder to decode the instructions detailed herein. In some examples, a decoder of a host processor 301 decodes the instructions to be executed by the FHE compute engine 240.

In some examples, the basic organization of the FHE compute engine 240 is a wide and flexible array of functional units organized in a butterfly configuration. The array of butterfly units is tightly coupled with a register file in scratch pad memory 322 in a scratch pad memory unit 302-0 capable of storing one or more of FHE operands (e.g., entire input and output ciphertexts), twiddle factor constants, relevant public key material, etc. In some examples, the FHE operands, twiddle factors, key information, etc. are stored as polynomial coefficients.

The FHE compute engine 240 performs polynomial multiplication, addition, modulo reduction, etc. Given aᵢ and bᵢ in [symbol] two polynomials a(x) and b(x) over the ring can be expressed as

$$a ( x ) = {a}_{0} + {a}_{1} x + {a}_{2} {x}^{2} + … {a}_{n - 1} {x}^{n - 1}$$

$$b ( x ) = {b}_{0} + {b}_{1} x + {b}_{2} {x}^{2} + … {b}_{n - 1} {x}^{n - 1}$$

Each of the scratch pad memory units 202 includes key generator circuitry 304 that is used during FHE relinearization to generate FHE relinearization public keys from a seed that is input to the Key generator circuitry 304 in a key generation seed (KG_seed) instruction sent by the host processors 301. The seed is used by the key generator circuitry 304 to generate FHE relinearization public keys locally within the scratch pad memory units 202 in the FHE accelerator 303. The scratch pad memory 322 to store coefficients used by the plurality of compute elements 310 to perform operations on polynomials.

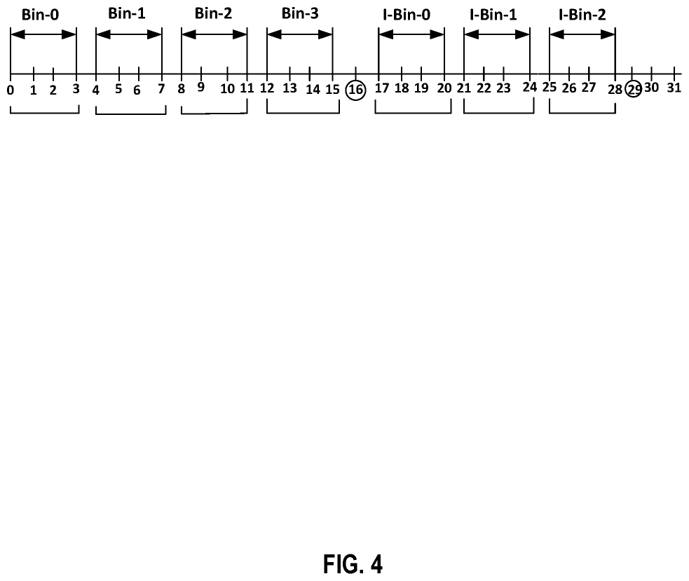

FIG. 4 is an example of integers modulo a power-of-two number in the number space of 0−(2ⁿ−1) generated by a pseudo-random number generator, where n is 5 (total number of distinct integers generated by the pseudo-random number generator are 2⁵ (32 (0 to 31)), the modulus q is 17 and bound (the largest integer in the range [q, 2ⁿ−1] to be mapped, where n=[log₂ q]) is 29.

Integers from [0, q−2] and [q, bound−1] are split into bins of equal size. The number of bins inside the range [0, q−2], nbin_inside is a power-of-two number. In the example shown in FIG. 4, there are four (2²) bins (Bin-0, Bin-1, Bin-2, Bin-3) inside the range [0, q−2] and each bin has four integers (Bin-0 (0-3), Bin-1 (4-7), Bin-2(8-11), Bin-3(12-15)). There are three bins (nbin_outside) of equal size in the range [q, bound−1], each bin has four integers (I-(Bin-0 (17-20), I-Bin-1 (21-24), I-Bin-2 (25-28)).

The integer values in the range [0, q−1](valid range) are valid integer value(s). The integers in the range [q, bound](integers greater than or equal to q and less than equal to bound) (invalid range) are invalid integer value(s). Instead of rejecting the invalid integers, the integers in the invalid range of invalid integer values [q, bound] are randomly mapped back to valid integers in the range [0, q−1] using additional random bits (bin_select) generated by another pseudo-random number generator. This considerably reduces the rejection rate while the uniformity condition is satisfied by appropriately mapping corner cases (integer q−1, integer bound).

In the embodiment shown in FIG. 4, with four bins (Bin-0, Bin-1, Bin-2, Bin-3) inside the range [0, q−2], two additional random bits (bin_select bits) are used to select one of the four bins (Bin-0, Bin-1, Bin-2, Bin-3) to map invalid integers in invalid bins (I-(Bin-0 (17-20), I-Bin-1 (21-24), I-Bin-2 (25-28)). For example, integer 17 in I-Bin-0 can be mapped to integer 0 in Bin-0, integer 4 in Bin-1, integer 8 in Bin-2 or integer 12 in Bin-3 dependent on the value of the bin_select bits.

Corner case integer (q−1) does not get mapped from any of the invalid bins (I-(Bin-0 (17-20), I-Bin-1 (21-24), I-Bin-2 (25-28)). To ensure uniformity of the distribution of the integers modulo q, the probability of sampling the corner case integer (q−1) should be equal to all the other valid integers q ([0, q−2]). There will still be a few rejected integers (29, 30, 31) outside I-Bin-2(25-28) and any one of them can be chosen to be mapped to the integer (q−1). For example, integer 29 can be mapped to the integer 16. If the probability for generating any random input is p, after the mapping of the invalid integers (17-28) in Bin 0-3, the integers in the range [0, q−2] has a sampling probability of:

$$p + \frac{nbin\_outside}{nbin\_inside} p .$$

In the example of the pseudo-random number generator, where n is 5 and can produce any number between 0 and 31, inclusive, at its output, the probability of getting any integer between 0 and 31 is the same, that is, 1/32. For an n-bit RNG, the sampling probability (p) of generating any integer between 0 and (2ⁿ−1) is ½ⁿ. For the corner case, the integer bound is mapped to the integer (q−1) at all times. The probability of getting the value (q−1) is p. Due to the mapping, the integer bound is also mapped to the integer (q−1), and the value bound can occur at the output of the pseudo-random number generator with the probability of p. Before mapping, either (q−1) or bound can occur at the output of the pseudo-random number generator), that is, they are mutually exclusive. Thus, the total probability of (q−1) after mapping is the sum of two probabilities, that is, p+p=2p.

The sampling probability is 2p if the integer bound (for example, integer 29) is always mapped to the integer (q−1) (for example, integer 16 when q=17). Thus, to ensure the uniformity of the corner case for (q−1) (for example, integer 16), the integer bound (for example, integer 29) is mapped to (q−1) (for example, integer 16) only nbin_outside (for example, 3) times out of nbin_inside (for example, 4) times based on the number of bins (4) in the range in the range [0, q−1] and the number of bins (3) in the range [q, bound−1]. For example, the integers in the range [0, 15] have a sampling probability of

$$p + \frac{3 p}{4} ,$$

and to match the sampling probability integer 29 is mapped to 16 only 3 out of 4 times, resulting in the same probability for integer (q−1)=16 as integers in the range [0,15], resulting in a rejection rate of about 7%.

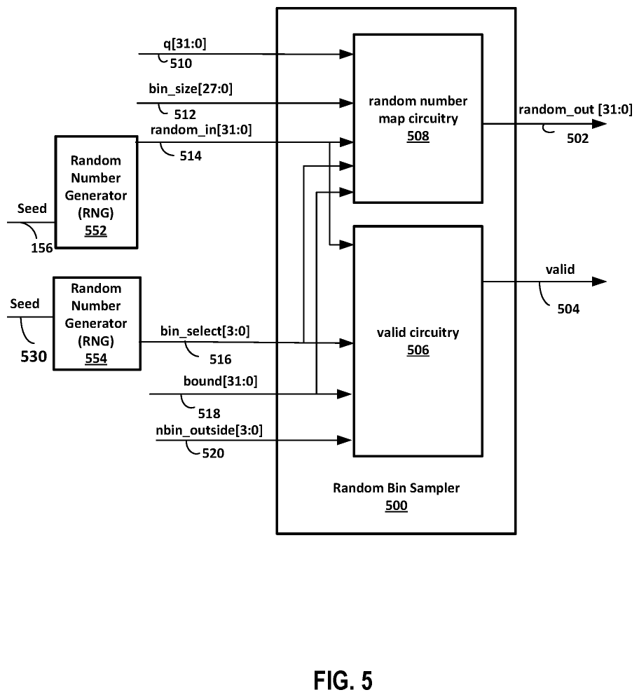

FIG. 5 is a block diagram of a random bin sampler 500 that reduces the rejection rate of the raw random number generator values generated by a random number generator 552 by randomly mapping the raw RNG values received from the random number generator 552 that are greater than or equal to q to one of the valid integer values inside the range [0, q−1] using additional random bits.

The random bin sampler 500 receives integers modulo a power-of-two number in the number space of 0−(2ⁿ−1) (referred to as raw random number generator (RNG) values) generated by the random number generator 552. The random bin sampler 500 uniformly maps the received raw RNG values from the number space of 0−(2ⁿ−1) to the ciphertext modulus space of 0−(q−1). An embodiment will be described for n=5 and q=17.

The random bin sampler 500 generates two outputs, random_out[31:0] 502 (the random output integer modulo q) and the corresponding valid signal 504. The state (1 or 0) of the valid signal 504 indicates whether random_out[31:0] 502 is valid. Values on the random_out[31:0] 502 are loaded in buffers coupled to random_out[31:0] 502 only when the valid signal 504 is valid (asserted, set to ‘1’).

The random bin sampler 500 includes random number map circuitry 508 and valid circuitry 506. The valid circuitry 506 outputs a valid signal 504 that is set to ‘1’ if the random number generator (RNG) value 514 received from the random number generator 552 will result in a valid random output integer modulo q after mapping.

In the embodiment shown in FIG. 5, the valid circuitry 506 sets the valid signal 504 to ‘1’ if random_in[31:0] 514 is less than bound[31:0] 518. If random_in[31:0] 514 is equal to bound[31:0] 518, the valid signal 504 is set to ‘1’ if bin_select[3:0] 516 is less than nbin_outside[3:0] 520. If random_in [31:0] 514 is greater than bound[31:0] 518, the valid signal 504 is set to ‘0’.

In the embodiment shown in FIG. 5, the random number map circuitry 508 receives random number integers (random_in[31:0] 514) generated by the random number generator 552. The random number map circuitry 508 also receives random number integers (bin_select[3:0] 516) generated by another random number generator 554 from another seed 530. The random number map circuitry 508 also receives the prime modulus q (q[31:0] 510) and the size of each bin (bin_size[27:0] 512). The prime modulus q (q[31:0] 510), the size of each bin (bin_size[27:0] 512), bound[31:0] 518 and nbin_outside[3:0] 520 are public metadata and are received in a Key Generation seed (KG_seed) instruction. The prime modulus q (q[31:0] 510) is an NTT-friendly prime modulus. NTT-friendly refers to the set of moduli satisfying the condition q ≡1 (mod 2N) for negacyclic NTT. The random integer input random_in[31:0] 514 is generated by random number generator 552 and is masked to have the same bit width as the modulus q[31:0] 510.

The random number map circuitry 508 receives random number integers (random_in[31:0] 514) generated by the random number generator 552. The random number map circuitry 508 also receives the bin_select[3:0] 516, bound[31:0] 518 and nbin_outside[3:0] 520. bound[31:0] 518 and nbin_outside[3:0] 520 in a Key Generation seed (KG_seed) instruction. bound[31:0] 518 is the largest integer in the range [q, 2ⁿ−1] to be mapped, where n=[log₂ q] and nbin_outside[3:0] 520 is the number of bins outside q spanning the integers in the range [q, bound−1].

In another embodiment, the random number map circuitry 508 uses modular reduction to map invalid integers in invalid bins (I-(Bin-0 (17-20), I-Bin-1 (21-24), I-Bin-2 (25-28)) to bins (Bin-0, Bin-1, Bin-2, Bin-3) inside the range [0, q−2]. A modular reduction modulo q[31:0] 510 is performed followed by an addition with bin_select[3:0] 516 multiplied by bin_size[27:0] 512.

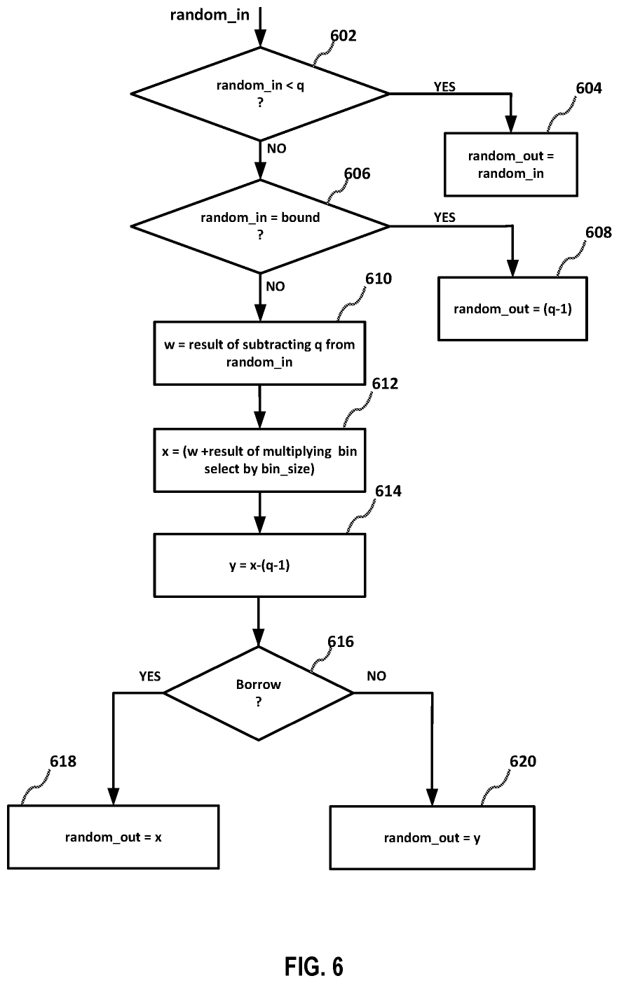

FIG. 6 is a flowgraph illustrating a method performed by the random number map circuitry 508 in the random bin sampler 500 that receives q[31:0] 510, random_in[31:0] 514, bound[31:0] 518, bin_select[3:0] 516, and bin_size[27:0] 512 as inputs, and maps from integers outside the range [0,q−1] to integers inside the range [0,q−1].

At block 602, if random_in[31:0] 514 is less than q[31:0] 510, processing continues with block 604. If not, processing continues with block 606.

At block 604, random_in[31:0] 514 is output as random_out[31:0] 502.

At block 606, if random_in[31:0] 514 is equal to bound[31:0] 518, processing continues with block 608. If not, processing continues with block 610.

At block 608, (q−1) is output as random_out[31:0] 502.

At block 610, q[31:0] 510 is subtracted from random_in[31:0] 514. The result of the subtraction is w[31:0]. Processing continues with block 612.

At block 612, bin_select[3:0] 516 is multiplied by bin_size[27:0] 512. The result of the multiplication of bin_select[3:0] 516 by bin_size[27:0] 512 is added to w[31:0]. The result of the addition is x[31:0]. Processing continues with block 614.

At block 614, (q−1) is subtracted from x[31:0]. The result of the subtraction is y[31:0]. Processing continues with block 616.

At block 616, if the result of the subtraction of (q−1) from x[31:0] is negative, that is, the subtraction produces a borrow, processing continues with block 618. If not, processing continues with block 620.

At block 618, x[31:0] is output as random_out[31:0] 502.

At block 620, y[31:0] is output as random_out[31:0] 502.

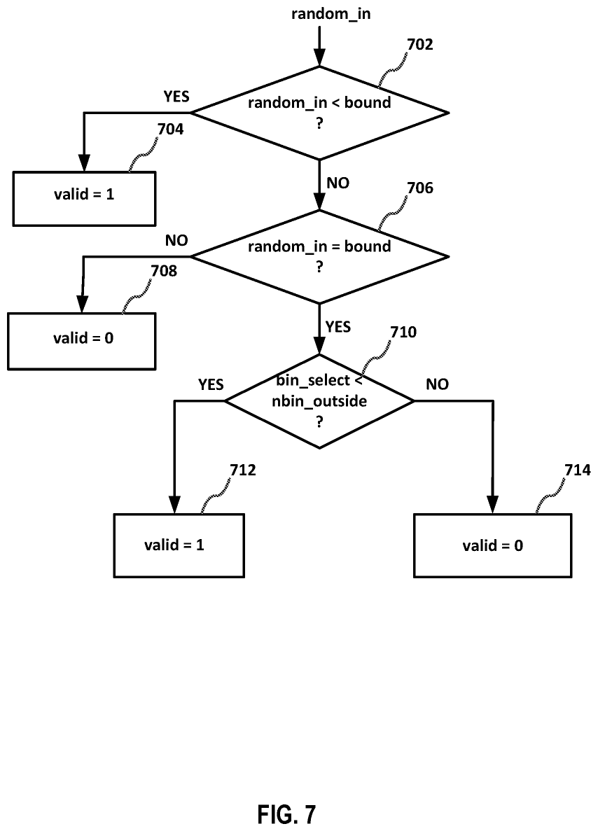

FIG. 7 is a flowgraph illustrating a method performed by the valid circuitry 506 in the random bin sampler 500 that receives random_in[31:0] 514, bound[31:0] 518, bin_select[3:0] 516, and nbin_outside[3:0] 520 as inputs, and outputs a valid signal 504.

The valid circuitry 506 outputs a valid signal 504 that is set to ‘1’, if the random number generator (RNG) value 514 received from the random number generator 552 is valid after mapping.

At block 702, if random_in[31:0] 514 is less than bound[31:0] 518, random_in[31:0]514 is valid, processing continues with block 704.

At block 704, random_in[31:0] 514 is valid, the valid circuitry 506 outputs a valid signal 504 that is set to ‘1’.

At block 706, if random_in[31:0] 514 is equal to bound[31:0] 518, processing continues with block 710. If random_in[31:0] 514 is not equal to bound[31:0] 518, random_in[31:0] 514 is not valid, processing continues with block 708.

At block 708, random_in[31:0] 514 is not valid, the valid circuitry 506 outputs a valid signal 504 that is set to ‘0’.

At block 710, if bin_select[3:0] 516 is less than nbin_outside[3:0] 520, random_in[31:0]514 is valid, processing continues with block 712. If not, random_in[31:0] 514 is not valid, processing continues with block 714.

At block 712, random_in[31:0] 514 is valid, the valid circuitry 506 outputs a valid signal 504 that is set to ‘1’.

At block 714, random_in[31:0] 514 is not valid, the valid circuitry 506 outputs a valid signal 504 that is set to ‘0’.

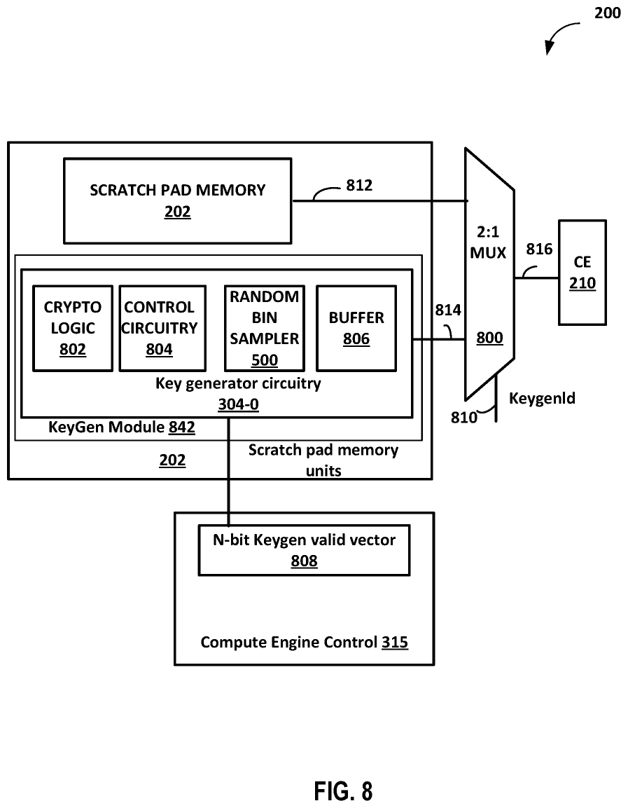

FIG. 8 illustrates an example of key generator circuitry 304 in the scratch pad memory units 202 shown in FIG. 2. A KeyGen module 842 (also referred to as a key generator circuit) includes key generator circuitry 304 that is distributed across the scratch pad memory units 102.

Each key generator circuitry 304-0, . . . , 304-N−1 includes crypto logic 802, random bin sampler 500, a buffer 806, and control circuitry 804 to manage key material generation. The crypto logic 802 generates raw random number generator values. The random bin sampler 500 to map the raw random values received from the crypto logic 802 from a number space to a ciphertext modulus space. The buffer 806 to store valid integer values received from the random bin sampler 500.

The key generator circuitry output 814 from the key generator circuitry 304 and the scratch pad memory output 812 from the scratch pad memory 302 are input to a 2:1 multiplexor 800. In the normal mode of operation, the state of the KG_load signal 810 is set so that the scratch pad memory output 812 from the scratch pad memory 302 is output from the 2:1 multiplexor 800 to the compute element (CE) 310. 512 Bytes of data are written every cycle to the compute element 310 on a CE bus 816.

After a KG_load instruction is executed, the state of the KG_load signal 810 is switched to allow the key generator circuitry 304 to write a 512 Byte key data output 814 from key generator circuitry 304 to the compute element 310 by setting the state of the KG_load signal 810 so that the 512 Byte key data output 814 from key generator circuitry 304 is output from the 2:1 multiplexor 800 to the compute element (CE) 310.

The compute engine control block 315 includes an N-bit Keygen valid vector 808 to track completion status of the keygen material in the N scratch pad memory units 102. The N-bit Keygen valid vector 808 includes one bit for each key generator circuitry 204. A respective bit in the N-bit Keygen valid vector 808 is asserted (for example, set to logic ‘1’) when the buffer 806 in the key generator circuitry 304 is full. A KG_load instruction reads the N-bit keygen valid vector 808, if all N bits are not valid, the KG_load instruction stalls until all N bits are valid. After all N bits are valid, the KG_load instruction reads the key material in the buffer 806 in each of the key generator circuitry 304 and clears (for example, sets bits to ‘0’) the N bits in the N-bit keygen valid vector 808. In an embodiment N is 16.

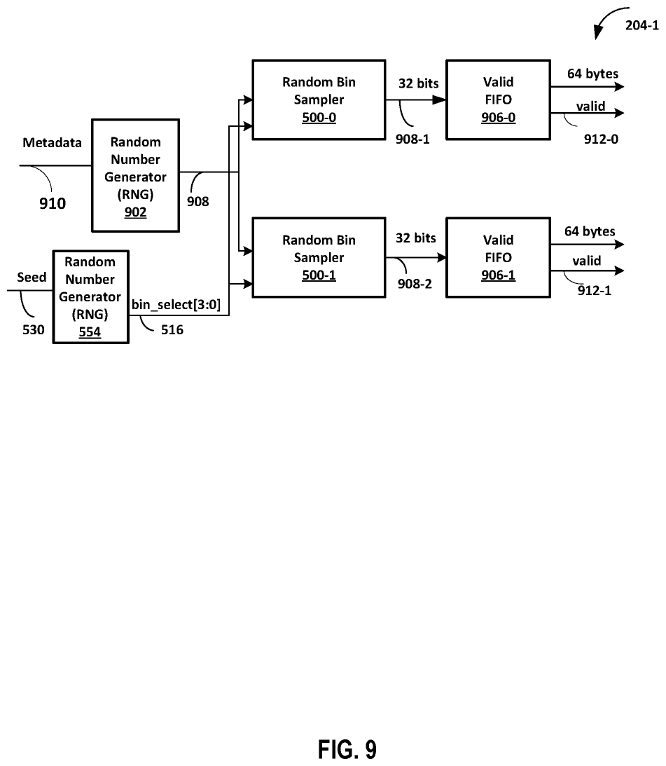

FIG. 9 is a block diagram of one key generator circuitry 304-0 in the KeyGen module 842 that includes 16 key generator circuitry 304 in the FHE accelerator 303.

Key generator circuitry 304-0 includes a random number generator (RNG) 902 that uses received metadata 910 to generate 64 random bits. The metadata 910 includes a random nonce, random data and random key numbers that are used to generate the 64 random bits. Key generator circuitry 204 also includes random number generator 554 to generate random number integers (bin_select[3:0] 516) from seed 530.

In an embodiment, the KeyGen module 842 uses key generator circuitry 304 of the PRESENT 80/64 cipher-based random number generator (RNG) 902 cascaded with random bin sampler 500-0 and random bin sampler 500-1. PRESENT is an Ultra-Lightweight Block Cipher with a 64-bit block size. In an embodiment, the key size is 80-bits. In other embodiment, the key size can be 128-bits. In other embodiments, other ciphers, for example, alternate symmetric key ciphers such as AES, ASCON, SIMON can be used.

Each key generator circuitry 304 generates 64 bits per cycle random output at 2 Giga Hz (GHz) resulting in an overall KeyGen module throughput of 2 Tera bits per second (Tbps). The pair of random bin samplers 500-0, 500-1 uniformly map raw RNG values from the number space of 0-2³² to the ciphertext modulus space of 0-q. The raw RNG values are generated by the cipher-based random number generator (RNG) 902.

Each of the random bin samplers 500-0, 500-1 to forward valid values to Valid FIFO 906-0 and Valid FIFO 906-1. A value is valid if it is in the ciphertext modulus space of 0-q. Valid FIFO 906-0 and Valid FIFO 906-1 are buffers to store valid values received from random bin samplers 500-0, 500-1 until 64 bytes of valid values are stored in Valid FIFO 906-0 and 64 bytes of valid values are stored in Valid FIFO 906-0. The state of valid signal 912-0 output from Valid FIFO 906-0 is set to “valid” when Valid FIFO 906-0 stores 64 valid bits. The state of valid signal 912-1 output from Valid FIFO 906-1 is set to “valid” when Valid FIFO 906-0 stores 64 valid bits.

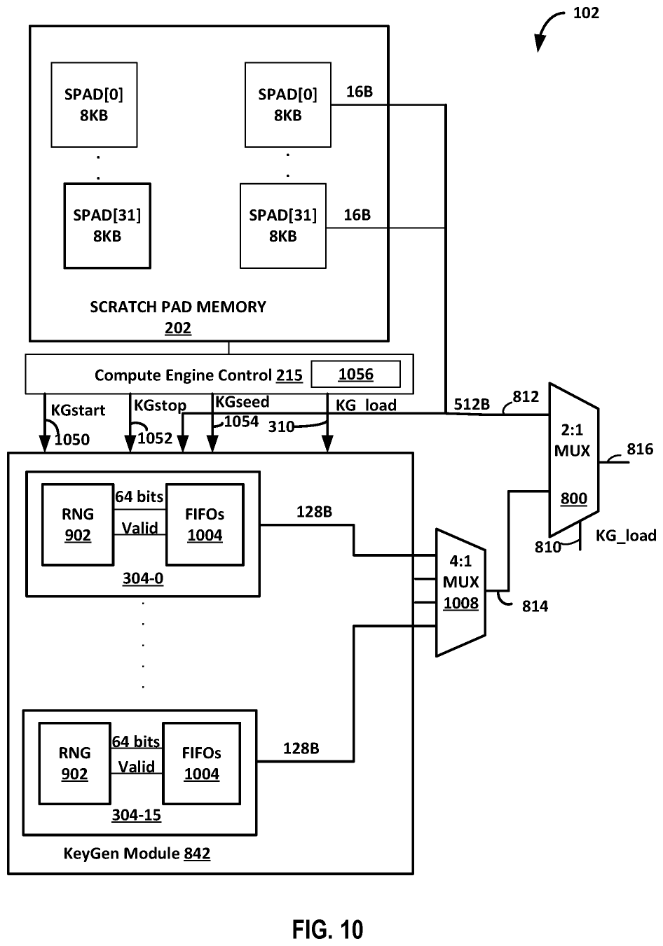

FIG. 10 is a block diagram of SPM units 202 in the FHE accelerator 303. SPM units 202 include scratch pad memory 302 and KeyGen module 842. The KeyGen module 842 includes 16 key generator circuitry 304-0, . . . , 204-15. Each key generator circuitry 304-0, . . . , 304-15 includes a random number generator (RNG) 902 and FIFOs 1004 to store valid bits.

Decode circuitry 1056 in the compute engine control block 315 decodes KeyGen instructions to generate a KG_start signal 1050, a KG_stop signal 1052, a KG_seed signal 1054 and a KG_load signal 810 to control the finite-state-machine in the KeyGen module 842.

Each key generator circuitry 304-0, . . . , 304-15 is loaded with a 208-bit seed value in response to a KG_seed instruction. The 208-bit seed value is sent to the KeyGen module 842 from the scratch pad memory 302 on the scratch pad memory output 812.

The KG_start signal 1050 is generated to start key generation operations in response to a KG_start_stop instruction when the decode circuitry 1056 in the compute engine control block 315 decodes the KG_start_stop instruction. The KG_start signal 1050 initiates parallel key generation operations in each key generator circuitry 304-0, . . . , 304-15. Local valid signals are used to gate the RNG 902 when the 128 bytes FIFO 1004-0, . . . 1004-15 for the respective key generator circuitry 304-0, . . . , 304-15 has been filled with 128 bytes of valid key material.

The KG_stop signal 1052 is generated in response to a KG_start_stop instruction when the decode circuitry in the compute engine control block 315 decodes a KG_start_stop instruction. If the keygen state machine is in an active state (generating key material), the KG_stop signal 1052 stops the key generation operations in each key generator circuitry 304-0, . . . , 304-15.

The KG_load signal 810 generated in response to a KG_start_stop instruction when the decode circuitry in the compute engine control block 315 decodes a KG_load instruction reads the 2 Kilo Bytes (KB) key material stored in the FIFOs 1004-0, . . . , 1004-15 over 4 cycles, with 512 bytes of key material read per cycle from FIFOs in four of the key generator circuitry 304-0, . . . , 304-15. An output 4:1 multiplexor 1008 routes the outputs of 4 of 16 FIFOs 1004-0, . . . 1004-15 to the KeyGen output 814 in each cycle.

The KeyGen output 814 from 4:1 multiplexor 1008 is multiplexed (2:1 multiplexor 800) with the scratchpad memory output 812 to drive the CE bus 816. After the 2 KB key material has been read from the FIFOs 1004-0, . . . , 1004-15 valid signals are reset.

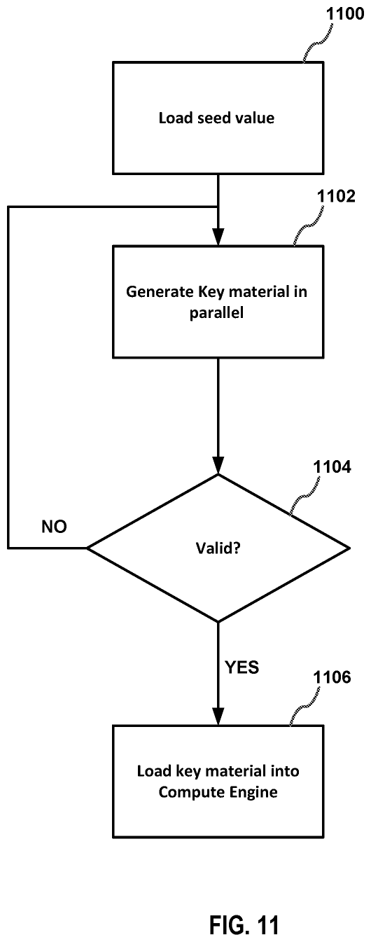

FIG. 11 is a flowgraph of a method performed in the FHE accelerator 303 to generate fully homomorphic encryption relinearization public keys.

At block 1100, a KG_seed instruction loads the seed (a 208-bit seed value) in each key generator circuitry 304-0, . . . , 204-15 in the KeyGen module 842. Processing continues with block 1102.

At block 1102, the KG_start signal 1050 generated when the scratch pad memory decodes a KG_start_stop instruction initiates parallel key generation operations in each key generator circuitry 304-0, . . . , 304-15. Processing continues with block 1104.

At block 1104, a KG_load instruction reads the keygen valid vector 808, if all bits in the keygen valid vector 808 are not valid, processing continues with block 1102 to continue to perform key generation operations. If all bits in the keygen valid vector 808 are valid, processing continues with block 1106.

At block 1106, all bits in the keygen valid vector 808 are valid. The KG_load instruction reads the key material in the buffer 806 in each of the key generator circuitry 304 and clears (for example, sets bits to ‘0’) the N bits in the N-bit keygen valid vector 808. The state of the KG_load signal 810 is set so that the 512-bit key data output 814 from the key generator circuitry 304 is output from the 2:1 multiplexor 800 to the Compute Engine (CE) 210.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

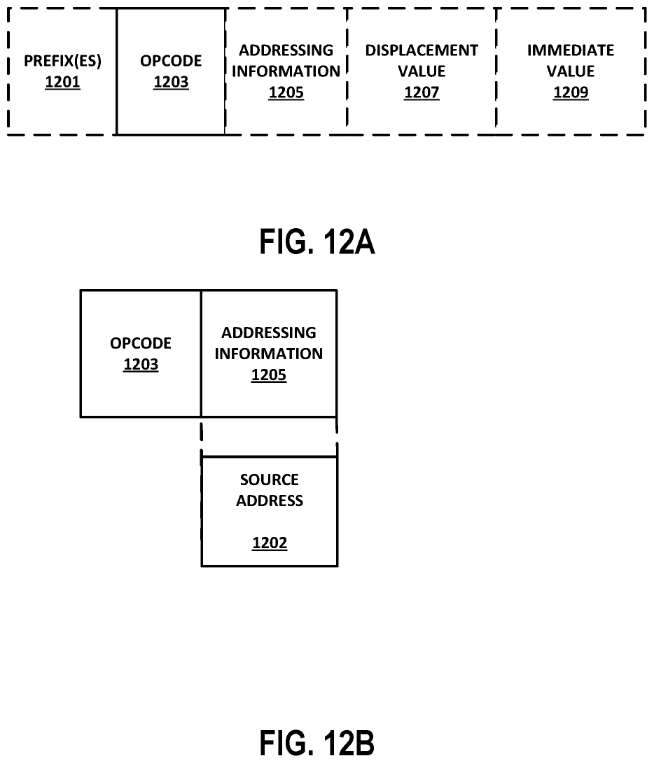

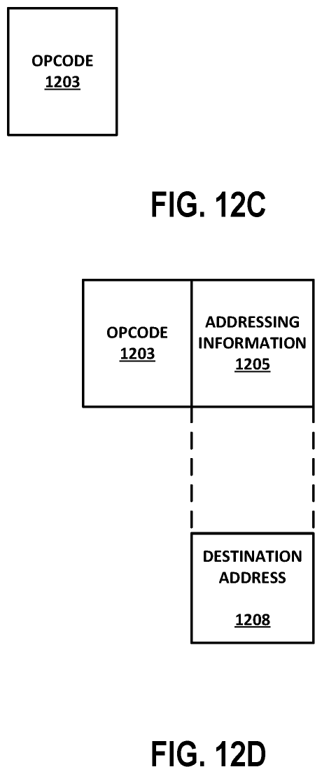

FIG. 12A illustrates examples of an instruction format. As illustrated, an instruction may include multiple components including, but not limited to, one or more fields for: one or more prefixes 1201, an opcode 1203, addressing information 1205 (e.g., register identifiers, memory addressing information, etc.), a displacement value 1207, and/or an immediate value 1209. Note that some instructions utilize some or all the fields of the format whereas others may only use the field for the opcode 1203. In some examples, the order illustrated is the order in which these fields are to be encoded, however, it should be appreciated that in other examples these fields may be encoded in a different order, combined, etc.

The prefix(es) field(s) 1201, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1203 is used to at least partially define the operation to be performed upon a decoding of the instruction. In some examples, a primary opcode encoded in the opcode field 1203 is one, two, or three bytes in length. In other examples, a primary opcode can be a different length. An additional 3-bit opcode field is sometimes encoded in another field.

The addressing information field 1205 is used to address one or more operands of the instruction, such as a location in memory or one or more registers.

FIG. 12B illustrates a Key Generation seed (KG_seed) instruction to load a seed stored in scratch pad memory 302 from the scratch pad memory 302 to key generation registers and to load a prime modulus q, bin size, bound, and nbin_outside (the number of bins in the range [q, bound−1]) from scratch pad memory 302 to be used by a random bin sampler 500 in key generator circuitry.

The instruction format is (opcode, metadata). The opcode field 1203 is used to define the operation (load seed stored in the scratchpad into key generation logic) to be performed upon a decoding of the instruction. The addressing information field 1205 is used to address the operands of the Key Generation seed instruction. The operand is a field (source address 1202) to indicate a source location in the scratch pad memory 202. In other embodiments, the key generation seed instruction to load a seed (seed material) from scratch pad memory to key generation registers may have fewer or more operands than what is shown in FIG. 12B.

The operands stored in the source location in the scratch pad memory 202 include a prime modulus q, bin_size, bound, and nbin_inside (the number of bins in the range [q, bound−1]) to be used by the random bin sampler 500.

FIG. 12C illustrates a Key Generation start stop (KG_start_stop) instruction to toggle the state of the Key Generation operation between start and stop and stop and start.

The instruction format is (opcode). The opcode field 1203 is used to define the operation (Key Generation start or stop) to be performed upon a decoding of the instruction. If the keygen state machine is in a stopped state, the KG_start_stop instruction starts the keygen state machine. If the keygen state machine is in an active state (generating key material), the KG_start_stop stops the keygen state machine. In another embodiment, a KG_start_stop instruction may not be used to stop, the key generation can stop automatically after the buffer is full.

In other embodiments, the key generation start stop instruction to toggle the state of the key generation operation may have fewer or more operands than what is shown in FIG. 12C.

FIG. 12D illustrates a Key Generation load (KG_load) instruction to load the key generated by the key generation instruction stored in a buffer in the scratch pad memory units 102-0, . . . , 102-N−1 from the buffer into the compute engine.

The instruction format is (opcode, dst_address). The opcode field 1203 is used to define the operation (load the key generated by the key generation instruction from the buffer into the compute engine). The addressing information field 1205 is used to address the operands of the Key Generation load instruction. The operand is a destination address 1208 to indicate a destination (for example, compute engine) for the key stored in the buffer. In other embodiments, the Key Generation load (KG_load) instruction to load the key generated by the key generation instruction from the buffer into the compute engine may have fewer or more operands than what is shown in FIG. 12D.

FIG. 13 illustrates an example computing system. Multiprocessor system 1300 is an interfaced system and includes a plurality of processors or cores including a first processor 1370 and a second processor 1380 coupled via an interface 1350 such as a point-to-point (P-P) interconnect, a fabric, and/or bus. In some examples, the first processor 1370 and the second processor 1380 are homogeneous. In some examples, first processor 1370 and the second processor 1380 are heterogenous. Though the example system 1300 is shown to have two processors, the system may have three or more processors, or may be a single processor system. In some examples, the computing system is a system on a chip (SoC).

Processors 1370 and 1380 are shown including integrated memory controller (IMC) circuitry 1372 and 1382, respectively. Processor 1370 also includes interface circuits 1376 and 1378; similarly, second processor 1380 includes interface circuits 1386 and 1388. Processors 1370, 1380 may exchange information via the interface 1350 using interface circuits 1378, 1388. IMCs 1372 and 1382 couple the processors 1370, 1380 to respective memories, namely a memory 1332 and a memory 1334, which may be portions of main memory (system memory) locally attached to the respective processors. The memory 1332 and memory 1334 to store instructions and data.

Processors 1370, 1380 may each exchange information with a network interface (NW I/F) 1390 via individual interfaces 1352, 1354 using interface circuits 1376, 1394, 1386, 1398. The network interface 1390 (e.g., one or more of an interconnect, bus, and/or fabric, and in some examples is a chipset) may optionally exchange information with a co-processor 1338 via an interface circuit 1392. In some examples, the co-processor 1338 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1370, 1380 or outside of both processors, yet connected with the processors via an interface such as a point to point (P-P) interconnect, such that either or both processors' local cache information may be stored in the shared cache if a processor is placed into a low power mode.

Network interface 1390 may be coupled to a first interface 1316 via interface circuit 1396. In some examples, first interface 1316 may be an interface such as a Peripheral Component Interconnect (PCI) interconnect, a PCI Express interconnect or another I/O interconnect. In some examples, first interface 1316 is coupled to a power control unit (PCU) 1 3 17, which may include circuitry, software, and/or firmware to perform power management operations with regard to the processors 1370, 1380 and/or co-processor 1338. PCU 1317 provides control information to a voltage regulator (not shown) to cause the voltage regulator to generate the appropriate regulated voltage. PCU 1317 also provides control information to control the operating voltage generated. In various examples, PCU 1317 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1317 is illustrated as being present as logic separate from the processor 1370 and/or processor 1380. In other cases, PCU 1317 may execute on a given one or more of cores (not shown) of processor 1370 or 1380. In some cases, PCU 1317 may be implemented as a microcontroller (dedicated or general-purpose) or other control logic configured to execute its own dedicated power management code, sometimes referred to as P-code. In yet other examples, power management operations to be performed by PCU 1317 may be implemented externally to a processor, such as by way of a separate power management integrated circuit (PMIC) or another component external to the processor. In yet other examples, power management operations to be performed by PCU 1317 may be implemented within BIOS or other system software.

Various I/O devices 1314 may be coupled to first interface 1316, along with a bus bridge 1318 which couples first interface 1316 to a second interface 1320. In some examples, one or more additional processor(s) 1315, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 1316. In some examples, second interface 1320 may be a low pin count (LPC) interface. Various devices may be coupled to second interface 1320 including, for example, a keyboard and/or mouse 1322, communication devices 1327 and storage circuitry 1328. Storage circuitry 1328 may be one or more non-transitory machine-readable storage media as described below, such as a disk drive or other mass storage device which may include instructions/code and data 1330 and may implement the storage 1328 in some examples. Further, an audio I/O 1324 may be coupled to second interface 1320. Note that other architectures than the point-to-point architecture described above are possible. For example, instead of the point-to-point architecture, a system such as multiprocessor system 1300 may implement a multi-drop interface or other such architecture.

### Example Core Architectures, Processors, and Computer Architectures.

Processor cores (“cores”) may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality.

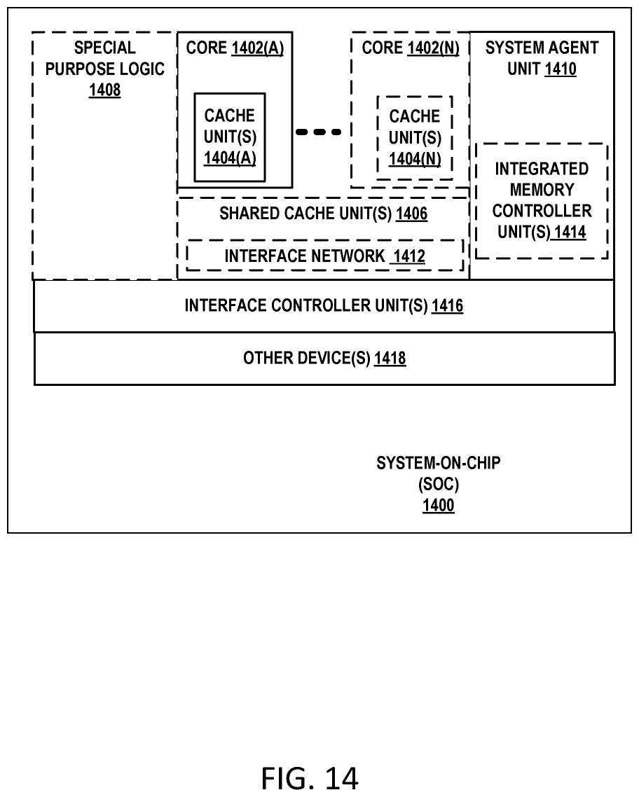

FIG. 14 illustrates a block diagram of an example SoC 1400 that may have one or more processor cores and an integrated memory controller. The SoC 1400 includes different components (hardware elements), also called “blocks” or subsystems.

The solid lined boxes illustrate an SoC 1400 with a single processor core 1402(A), system agent unit circuitry 1410, and a set of one or more interface controller unit(s) circuitry 1416, while the optional addition of the dashed lined boxes illustrates an alternative SoC 1400 with multiple cores 1402(A)-(N), a set of one or more integrated memory controller unit(s) circuitry 1414 in the system agent unit circuitry 1410, and special purpose logic 1408, as well as a set of one or more interface controller units circuitry 1416. Note that the SoC 1400 may be one of the processors 1370 or 1380, or co-processor 1338 or 1315 of FIG. 13.

Thus, different implementations of the SoC 1400 may include: 1) a CPU with the special purpose logic 1408 being integrated graphics and/or scientific (throughput) logic (which may include one or more cores, not shown), and the cores 1402(A)-(N) being one or more general purpose cores (e.g., general purpose in-order cores, general purpose out-of-order cores, or a combination of the two); 2) a coprocessor with the cores 1402(A)-(N) being a large number of special purpose cores intended primarily for graphics and/or scientific (throughput); and 3) a coprocessor with the cores 1402(A)-(N) being a large number of general purpose in-order cores. Thus, the SoC 1400 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The SoC 1400 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1404(A)-(N) within the cores 1402(A)-(N), a set of one or more shared cache unit(s) circuitry 1406, and external memory (not shown) coupled to the set of integrated memory controller unit(s) circuitry 1414. The set of one or more shared cache unit(s) circuitry 1406 may include one or more mid-level caches, such as level 2 (L2), level 3 (L3), level 4 (L4), or other levels of cache, such as a last level cache (LLC), and/or combinations thereof. While in some examples interface network circuitry 1412 (e.g., a ring interconnect) interfaces the special purpose logic 1408 (e.g., integrated graphics logic), the set of shared cache unit(s) circuitry 1406, and the system agent unit circuitry 1410, alternative examples use any number of well-known techniques for interfacing such units. In some examples, coherency is maintained between one or more of the shared cache unit(s) circuitry 1406 and cores 1402(A)-(N). In some examples, interface controller units circuitry 1416 couple the cores 1402 to one or more other devices 1418 such as one or more I/O devices, storage, one or more communication devices (e.g., wireless networking, wired networking, etc.), etc.

In some examples, one or more of the cores 1402(A)-(N) are capable of multi-threading. The system agent unit circuitry 1410 includes those components coordinating and operating cores 1402(A)-(N). The system agent unit circuitry 1410 may include, for example, power control unit (PCU) circuitry and/or display unit circuitry (not shown). The PCU may be or may include logic and components needed for regulating the power state of the cores 1402(A)-(N) and/or the special purpose logic 1408 (e.g., integrated graphics logic). The display unit circuitry is for driving one or more externally connected displays.

The cores 1402(A)-(N) may be homogenous in terms of instruction set architecture (ISA). Alternatively, the cores 1402(A)-(N) may be heterogeneous in terms of ISA; that is, a subset of the cores 1402(A)-(N) may be capable of executing an ISA, while other cores may be capable of executing only a subset of that ISA or another ISA.

### Example Core Architectures—In-Order and Out-of-Order Core Block Diagram.

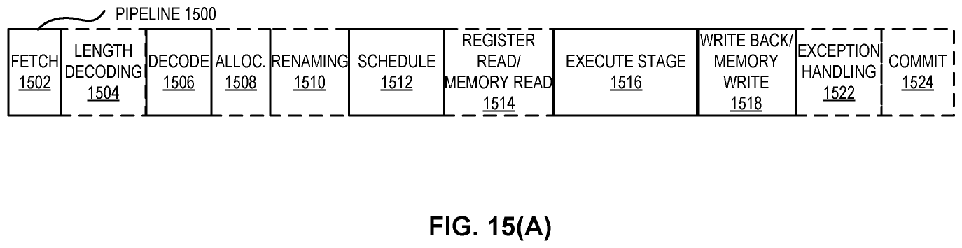

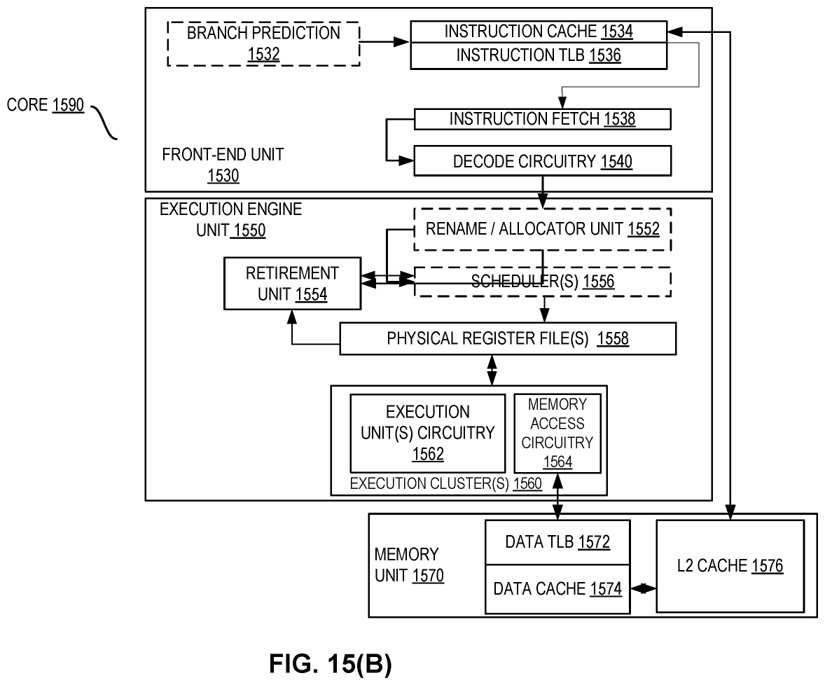

FIG. 15(A) is a block diagram illustrating both an example in-order pipeline and an example register renaming, out-of-order issue/execution pipeline according to examples. FIG. 15(B) is a block diagram illustrating both an example in-order architecture core and an example register renaming, out-of-order issue/execution architecture core to be included in a processor according to examples. The solid lined boxes in FIGS. 15(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 15(A), a processor pipeline 1500 includes a fetch stage 1502, an optional length decoding stage 1504, a decode stage 1506, an optional allocation (Alloc) stage 1508, an optional renaming stage 1510, a schedule (also known as a dispatch or issue) stage 1512, an optional register read/memory read stage 1514, an execute stage 1516, a write back/memory write stage 1518, an optional exception handling stage 1522, and an optional commit stage 1524. One or more operations can be performed in each of these processor pipeline stages. For example, during the fetch stage 1502, one or more instructions are fetched from instruction memory, and during the decode stage 1506, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1506 and the register read/memory read stage 1514 may be combined into one pipeline stage. In one example, during the execute stage 1516, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 15(B) may implement the processor pipeline 1500 as follows: 1) the instruction fetch circuitry 1538 performs the fetch decoding stage 1502 and length decoding stage 1504; 2) the decode circuitry 1540 performs the decode stage 1506; 3) the rename/allocator unit circuitry 1552 performs the allocation stage 1508 and renaming stage 1510; 4) the scheduler(s) circuitry 1556 performs the schedule stage 1512; 5) the physical register file(s) circuitry 1558 and the memory unit circuitry 1570 perform the register read/memory read stage 1514; the execution cluster(s) 1560 perform the execute stage 1516; 6) the memory unit circuitry 1570 and the physical register file(s) circuitry 1558 perform the write back/memory write stage 1518; 7) various circuitry may be involved in the exception handling stage 1522; and 8) the retirement unit circuitry 1554 and the physical register file(s) circuitry 1558 perform the commit stage 1524.

FIG. 15(B) shows a processor core 1590 including front-end unit circuitry 1530 coupled to execution engine unit circuitry 1550, and both are coupled to memory unit circuitry 1570. The core 1590 may be a reduced instruction set architecture computing (RISC) core, a complex instruction set architecture computing (CISC) core, a very long instruction word (VLIW) core, or a hybrid or alternative core type. As yet another option, the core 1590 may be a special-purpose core, such as, for example, a network or communication core, compression engine, coprocessor core, general purpose computing graphics processing unit (GPGPU) core, graphics core, or the like.

The front-end unit circuitry 1530 may include branch prediction circuitry 1532 coupled to instruction cache circuitry 1534, which is coupled to an instruction translation lookaside buffer (TLB) 1536, which is coupled to instruction fetch circuitry 1538, which is coupled to decode circuitry 1540. In one example, the instruction cache circuitry 1534 is included in the memory unit circuitry 1570 rather than the front-end circuitry 1530. The decode circuitry 1540 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1540 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1540 may be implemented using various different mechanisms. Examples of suitable mechanisms include, but are not limited to, look-up tables, hardware implementations, programmable logic arrays (PLAs), microcode read only memories (ROMs), etc. In one example, the core 1590 includes a microcode ROM (not shown) or other medium that stores microcode for certain macroinstructions (e.g., in decode circuitry 1540 or otherwise within the front-end circuitry 1530). In one example, the decode circuitry 1540 includes a micro-operation (micro-op) or operation cache (not shown) to hold/cache decoded operations, micro-tags, or micro-operations generated during the decode or other stages of the processor pipeline 1500. The decode circuitry 1540 may be coupled to rename/allocator unit circuitry 1552 in the execution engine circuitry 1550.

The execution engine circuitry 1550 includes the rename/allocator unit circuitry 1552 coupled to retirement unit circuitry 1554 and a set of one or more scheduler(s) circuitry 1556. The scheduler(s) circuitry 1556 represents any number of different schedulers, including reservations stations, central instruction window, etc. In some examples, the scheduler(s) circuitry 1556 can include arithmetic logic unit (ALU) scheduler/scheduling circuitry, ALU queues, address generation unit (AGU) scheduler/scheduling circuitry, AGU queues, etc. The scheduler(s) circuitry 1556 is coupled to the physical register file(s) circuitry 1558. Each of the physical register file(s) circuitry 1558 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1558 includes vector registers unit circuitry, writemask registers unit circuitry, and scalar register unit circuitry. These register units may provide architectural vector registers, vector mask registers, general-purpose registers, etc. The physical register file(s) circuitry 1558 is coupled to the retirement unit circuitry 1554 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1554 and the physical register file(s) circuitry 1558 are coupled to the execution cluster(s) 1560. The execution cluster(s) 1560 includes a set of one or more execution unit(s) circuitry 1562 and a set of one or more memory access circuitry 1564. The execution unit(s) circuitry 1562 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1556, physical register file(s) circuitry 1558, and execution cluster(s) 1560 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1564). It should also be understood that where separate pipelines are used, one or more of these pipelines may be out-of-order issue/execution and the rest in-order.

In some examples, the execution engine unit circuitry 1550 may perform load store unit (LSU) address/data pipelining to an Advanced Microcontroller Bus (AMB) interface (not shown), and address phase and writeback, data phase load, store, and branches.

The set of memory access circuitry 1564 is coupled to the memory unit circuitry 1570, which includes data TLB circuitry 1572 coupled to data cache circuitry 1574 coupled to level 2 (L2) cache circuitry 1576. In one example, the memory access circuitry 1564 may include load unit circuitry, store address unit circuitry, and store data unit circuitry, each of which is coupled to the data TLB circuitry 1572 in the memory unit circuitry 1570. The instruction cache circuitry 1534 is further coupled to the level 2 (L2) cache circuitry 1576 in the memory unit circuitry 1570. In one example, the instruction cache 1534 and the data cache 1574 are combined into a single instruction and data cache (not shown) in L2 cache circuitry 1576, level 3 (L3) cache circuitry (not shown), and/or main memory. The L2 cache circuitry 1576 is coupled to one or more other levels of cache and eventually to a main memory.

The core 1590 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1590 includes logic to support a packed data instruction set architecture extension (e.g., AVX1, AVX2), thereby allowing the operations used by many multimedia applications to be performed using packed data.

### Example Execution Unit(s) Circuitry.

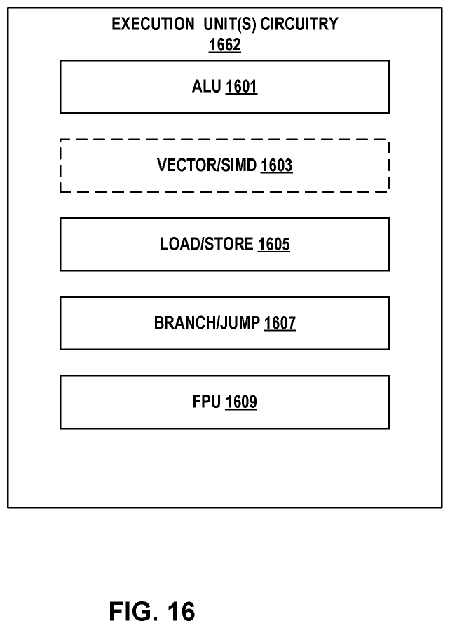

FIG. 16 illustrates examples of execution unit(s) circuitry 1662, such as execution unit(s) circuitry 1562 of FIG. 15(B). As illustrated, execution unit(s) circuitry 1562 may include one or more ALU circuits 1601, optional vector/single instruction multiple data (SIMD) circuits 1603, load/store circuits 1605, branch/jump circuits 1607, and/or Floating-point unit (FPU) circuits 1609. ALU circuits 1601 perform integer arithmetic and/or Boolean operations. Vector/SIMD circuits 1603 perform vector/SIMD operations on packed data (such as SIMD/vector registers). Load/store circuits 1605 execute load and store instructions to load data from memory into registers or store from registers to memory. Load/store circuits 1605 may also generate addresses. Branch/jump circuits 1607 cause a branch or jump to a memory address depending on the instruction. FPU circuits 1609 perform floating-point arithmetic. The width of the execution unit(s) circuitry 1562 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

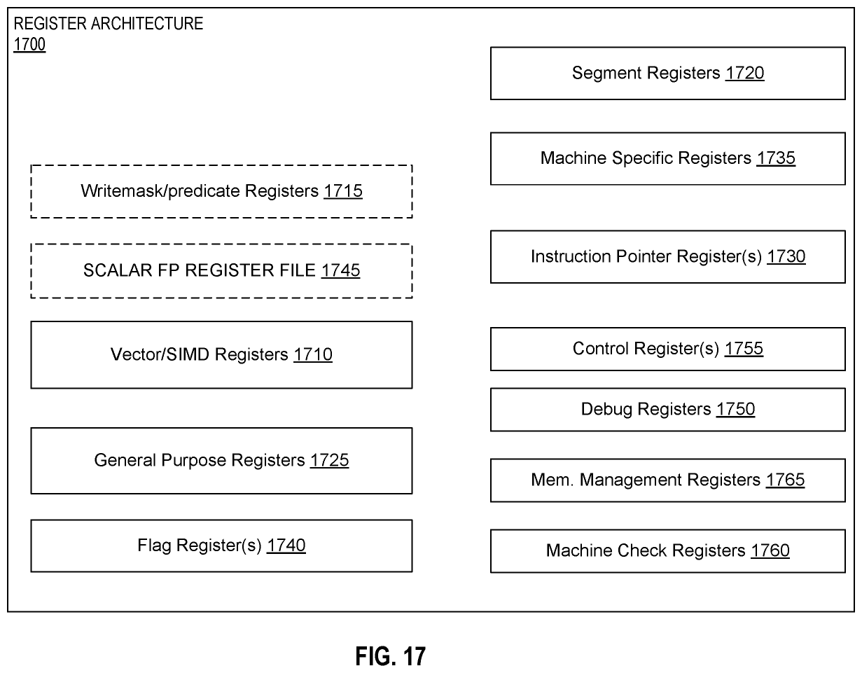

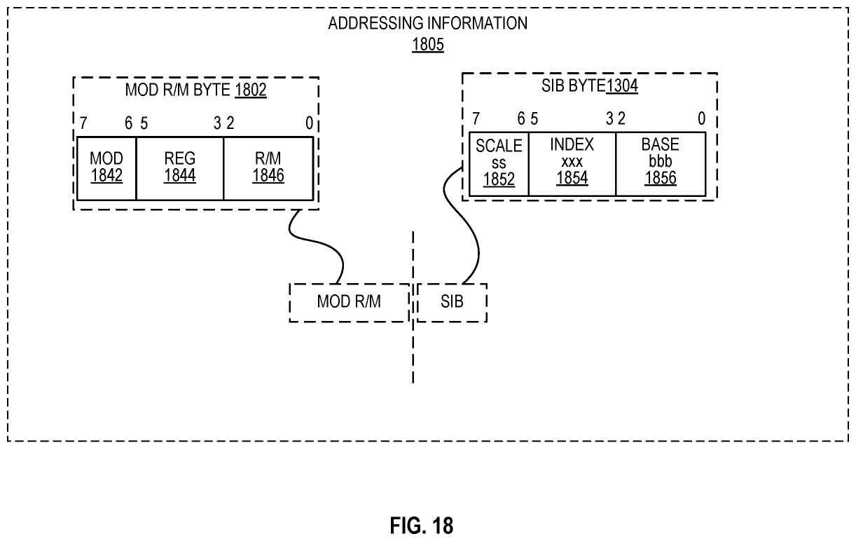

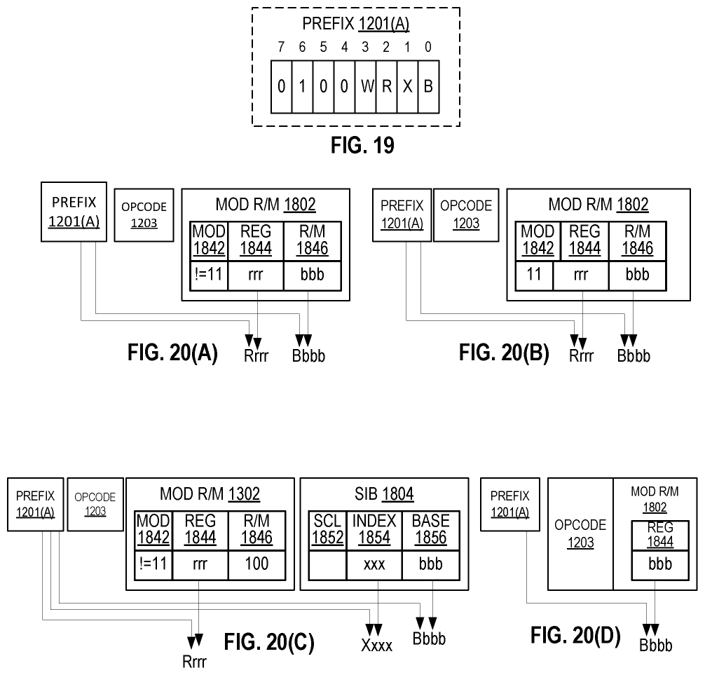

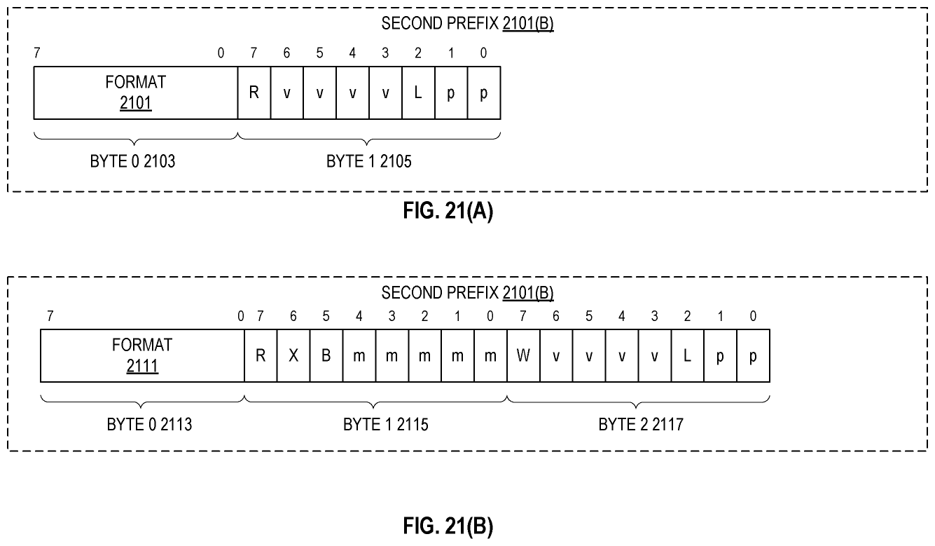

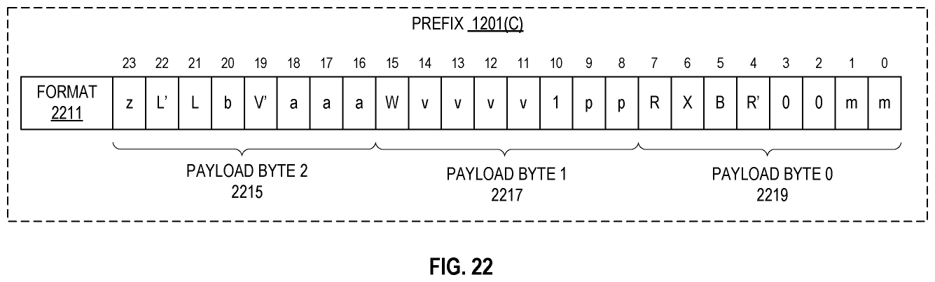

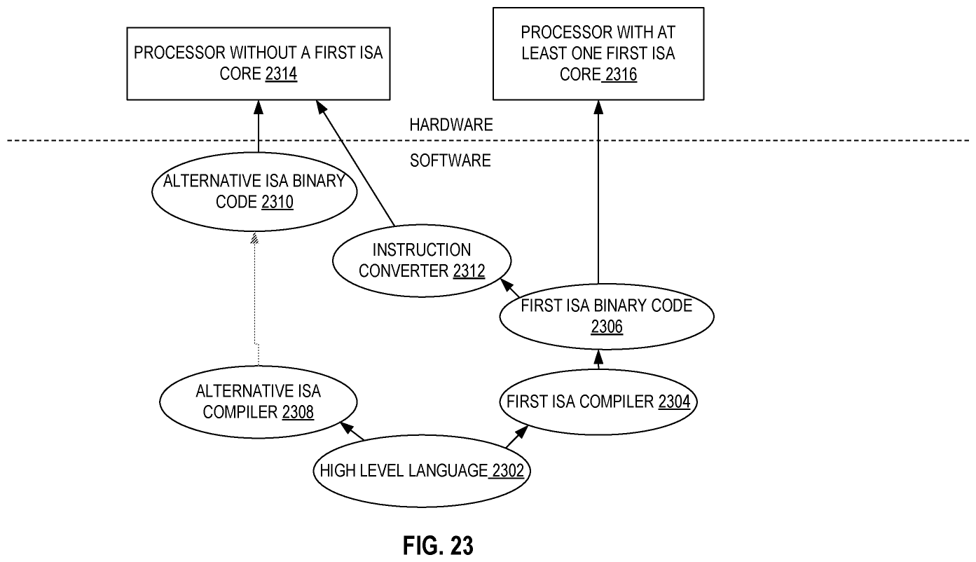

FIG. 17 is a block diagram of a register architecture 1700 according to some examples. As illustrated, the register architecture 1700 includes vector/SIMD registers 1710 that vary from 128-bit to 1,024 bits width. In some examples, the vector/SIMD registers 1710 are physically 512-bits and, depending upon the mapping, only some of the lower bits are used. For example, in some examples, the vector/SIMD registers 1710 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1700 includes writemask/predicate registers 1715. For example, in some examples, there are 8 writemask/predicate registers (sometimes called k0 through k7) that are each 16-bit, 32-bit, 64-bit, or 128-bit in size. Writemask/predicate registers 1715 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1715 corresponds to a data element position of the destination. In other examples, the writemask/predicate registers 1715 are scalable and consists of a set number of enable bits for a given vector element (e.g., 8 enable bits per 64-bit vector element).

The register architecture 1700 includes a plurality of general-purpose registers 1725. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1700 includes scalar floating-point (FP) register file 1745 which is used for scalar floating-point operations on 32/64/80-bit floating-point data using the x86 instruction set architecture extension or as MMX registers to perform operations on 64-bit packed integer data, as well as to hold operands for some operations performed between the MMX and XMM registers.

One or more flag registers 1740 (e.g., EFLAGS, RFLAGS, etc.) store status and control information for arithmetic, compare, and system operations. For example, the one or more flag registers 1740 may store condition code information such as carry, parity, auxiliary carry, zero, sign, and overflow. In some examples, the one or more flag registers 1740 are called program status and control registers.

Segment registers 1720 contain segment points for use in accessing memory. In some examples, these registers are referenced by the names CS, DS, SS, ES, FS, and GS.

Machine specific registers (MSRs) 1735 control and report on processor performance. Most MSRs 1735 handle system-related functions and are not accessible to an application program. Machine check registers 1760 consist of control, status, and error reporting MSRs that are used to detect and report on hardware errors.

One or more instruction pointer register(s) 1730 store an instruction pointer value. Control register(s) 1755 (e.g., CR0-CR4) determine the operating mode of a processor (e.g., processor 870, 880, 838, 815, and/or 1400) and the characteristics of a currently executing task. Debug registers 1750 control and allow for the monitoring of a processor or core's debugging operations.

Memory (mem) management registers 1765 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1700 may, for example, be used in register file/memory, or physical register file(s) circuitry 1558.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

FIG. 18 illustrates examples of the addressing information field 1805. In this illustration, an optional MOD R/M byte 1802 and an optional Scale, Index, Base (SIB) byte 1804 are shown. The MOD R/M byte 1802 and the SIB byte 1804 are used to encode up to two operands of an instruction, each of which is a direct register or effective memory address. Note that both of these fields are optional in that not all instructions include one or more of these fields. The MOD R/M byte 1802 includes a MOD field 1842, a register (reg) field 1844, and R/M field 1846.

The content of the MOD field 1842 distinguishes between memory access and non-memory access modes. In some examples, when the MOD field 1842 has a binary value of 11 (11b), a register-direct addressing mode is utilized, and otherwise a register-indirect addressing mode is used.

The register field 1844 may encode either the destination register operand or a source register operand or may encode an opcode extension and not be used to encode any instruction operand. The content of register field 1844, directly or through address generation, specifies the locations of a source or destination operand (either in a register or in memory). In some examples, the register field 1844 is supplemented with an additional bit from a prefix (e.g., prefix 1201) to allow for greater addressing.

The R/M field 1846 may be used to encode an instruction operand that references a memory address or may be used to encode either the destination register operand or a source register operand. Note the R/M field 1846 may be combined with the MOD field 1842 to dictate an addressing mode in some examples.

The SIB byte 1804 includes a scale field 1852, an index field 1854, and a base field 1856 to be used in the generation of an address. The scale field 1852 indicates a scaling factor. The index field 1854 specifies an index register to use. In some examples, the index field 1854 is supplemented with an additional bit from a prefix (e.g., prefix 1201) to allow for greater addressing. The base field 1856 specifies a base register to use. In some examples, the base field 1856 is supplemented with an additional bit from a prefix (e.g., prefix 1201) to allow for greater addressing. In practice, the content of the scale field 1852 allows for the scaling of the content of the index field 1854 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1207 provides this value. Additionally, in some examples, a displacement factor usage is encoded in the MOD field of the addressing information field 1205 that indicates a compressed displacement scheme for which a displacement value is calculated and stored in the displacement field 1207.

In some examples, the immediate value field 1209 specifies an immediate value for the instruction. An immediate value may be encoded as a 1-byte value, a 2-byte value, a 4-byte value, etc.

FIG. 19 illustrates examples of a first prefix 1201(A). In some examples, the first prefix 1201(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1201(A) may specify up to three registers using 3-bit fields depending on the format: 1) using the reg field 1844 and the R/M field 1846 of the MOD R/M byte 1802; 2) using the MOD R/M byte 1802 with the SIB byte 1804 including using the reg field 1844 and the base field 1856 and index field 1854; or 3) using the register field of an opcode.

In the first prefix 1201(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 1844 and MOD R/M R/M field 1846 alone can each only address 8 registers.

In the first prefix 1201(A), bit position 2 (R) may be an extension of the MOD R/M reg field 1844 and may be used to modify the MOD R/M reg field 1844 when that field encodes a general-purpose register, a 64-bit packed data register (e.g., a SSE register), or a control or debug register. R is ignored when MOD R/M byte 1802 specifies other registers or defines an extended opcode.

Bit position 1 (X) may modify the SIB byte index field 1854.

Bit position 0 (B) may modify the base in the MOD R/M R/M field 1846 or the SIB byte base field 1856; or it may modify the opcode register field used for accessing general purpose registers (e.g., general purpose registers 1725).

FIGS. 20(A)-(D) illustrate examples of how the R, X, and B fields of the first prefix 1201(A) are used. FIG. 20(A) illustrates R and B from the first prefix 1201(A) being used to extend the reg field 1844 and R/M field 1846 of the MOD R/M byte 1802 when the SIB byte 1804 is not used for memory addressing. FIG. 20(B) illustrates R and B from the first prefix 1201(A) being used to extend the reg field 1844 and R/M field 1846 of the MOD R/M byte 1802 when the SIB byte 1804 is not used (register-register addressing). FIG. 20(C) illustrates R, X, and B from the first prefix 1201(A) being used to extend the reg field 1844 of the MOD R/M byte 1802 and the index field 1854 and base field 1856 when the SIB byte 1804 being used for memory addressing. FIG. 20(D) illustrates B from the first prefix 1201(A) being used to extend the reg field 1844 of the MOD R/M byte 1802 when a register is encoded in the opcode 1203.

FIGS. 21(A)-(B) illustrate examples of a second prefix 1201(B). In some examples, the second prefix 1201(B) is an example of a VEX prefix. The second prefix 1201(B) encoding allows instructions to have more than two operands, and allows SIMD vector registers (e.g., vector/SIMD registers 1710) to be longer than 64-bits (e.g., 128-bit and 256-bit). The use of the second prefix 1201(B) provides for three-operand (or more) syntax. For example, previous two-operand instructions performed operations such as A=A+B, which overwrites a source operand. The use of the second prefix 1201(B) enables operands to perform nondestructive operations such as A=B+C.

In some examples, the second prefix 1201(B) comes in two forms—a two-byte form and a three-byte form. The two-byte second prefix 1201(B) is used mainly for 128-bit, scalar, and some 256-bit instructions; while the three-byte second prefix 1201(B) provides a compact replacement of the first prefix 1201(A) and 3-byte opcode instructions.

FIG. 21(A) illustrates examples of a two-byte form of the second prefix 1201(B). In one example, a format field 2101 (byte 0 2103) contains the value C5H. In one example, byte 1 2105 includes an “R” value in bit[7]. This value is the complement of the “R” value of the first prefix 1201(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (is complement) form and valid for instructions with 2 or more source operands; 2) encode the destination register operand, specified in is complement form for certain vector shifts; or 3) not encode any operand, the field is reserved and should contain a certain value, such as 1111b.

Instructions that use this prefix may use the MOD R/M R/M field 1846 to encode the instruction operand that references a memory address or encode either the destination register operand or a source register operand.

Instructions that use this prefix may use the MOD R/M reg field 1844 to encode either the destination register operand or a source register operand, or to be treated as an opcode extension and not used to encode any instruction operand.

For instruction syntax that support four operands, vvvv, the MOD R/M R/M field 1846 and the MOD R/M reg field 1844 encode three of the four operands. Bits[7:4] of the immediate value field 1209 are then used to encode the third source register operand.

FIG. 21(B) illustrates examples of a three-byte form of the second prefix 1201(B). In one example, a format field 2111 (byte 0 2113) contains the value C4H. Byte 1 2115 includes in bits[7:5]“R,” “X,” and “B” which are the complements of the same values of the first prefix 1201(A). Bits[4:0] of byte 1 2115 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit[7] of byte 2 2117 is used similar to W of the first prefix 1201(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (Is complement) form and valid for instructions with 2 or more source operands; 2) encode the destination register operand, specified in is complement form for certain vector shifts; or 3) not encode any operand, the field is reserved and should contain a certain value, such as 1111b.

Instructions that use this prefix may use the MOD R/M R/M field 1846 to encode the instruction operand that references a memory address or encode either the destination register operand or a source register operand.

Instructions that use this prefix may use the MOD R/M reg field 1844 to encode either the destination register operand or a source register operand, or to be treated as an opcode extension and not used to encode any instruction operand.

For instruction syntax that support four operands, vvvv, the MOD R/M R/M field 1846, and the MOD R/M reg field 1844 encode three of the four operands. Bits[7:4] of the immediate value field 1209 are then used to encode the third source register operand.

FIG. 22 illustrates examples of a third prefix 1201(C). In some examples, the third prefix 1201(C) is an example of an EVEX prefix. The third prefix 1201(C) is a four-byte prefix.

The third prefix 1201(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 17) or predication utilize this prefix. Opmask register allow for conditional processing or selection control. Opmask instructions, whose source/destination operands are opmask registers and treat the content of an opmask register as a single value, are encoded using the second prefix 1201(B).

The third prefix 1201(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1201(C) is a format field 2211 that has a value, in one example, of 62H. Subsequent bytes are referred to as payload bytes 2215-2219 and collectively form a 24-bit value of P[23:0] providing specific capability in the form of one or more fields (detailed herein).

In some examples, P[1:0] of payload byte 2219 are identical to the low two mm bits. P[3:2] are reserved in some examples. Bit P[4](R′) allows access to the high 16 vector register set when combined with P[7] and the MOD R/M reg field 1844. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1844 and MOD R/M R/M field 1846. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (Is complement) form and valid for instructions with 2 or more source operands; 2) encode the destination register operand, specified in is complement form for certain vector shifts; or 3) not encode any operand, the field is reserved and should contain a certain value, such as 1111b.

P[15] is similar to W of the first prefix 1201(A) and second prefix 2211(B) and may serve as an opcode extension bit or operand size promotion.

P[18:16] specify the index of a register in the opmask (writemask) registers (e.g., writemask/predicate registers 1715). In one example, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 1201(C) are detailed in the following tables.

TABLE 1
32-Register Support in 64-bit Mode

| | | | | REG. | |
|---|---|---|---|---|---|
| | 4 | 3 | [2:0] | TYPE | COMMON USAGES |
| REG | R′ | R | MOD R/M | GPR, | Destination or Source |
| | | | reg | Vector | |
| VVVV | V′ | vvvv | | GPR, | 2nd Source or Destination |
| | | | | Vector | |
| RM | X | B | MOD R/M | GPR, | 1st Source or Destination |
| | | | R/M | Vector | |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 23 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 23 shows a program in a high-level language 2302 may be compiled using a first ISA compiler 2304 to generate first ISA binary code 2306 that may be natively executed by a processor with at least one first ISA core 2316. The processor with at least one first ISA core 2316 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 2304 represents a compiler that is operable to generate first ISA binary code 2306 (e.g., object code) that can, with or without additional linkage processing, be executed on the processor with at least one first ISA core 2316. Similarly, FIG. 23 shows the program in the high-level language 2302 may be compiled using an alternative ISA compiler 2308 to generate alternative ISA binary code 2310 that may be natively executed by a processor without a first ISA core 2314. The instruction converter 2312 is used to convert the first ISA binary code 2306 into code that may be natively executed by the processor without a first ISA core 2314. This converted code is not necessarily to be the same as the alternative ISA binary code 2310; however, the converted code will accomplish the general operation and be made up of instructions from the alternative ISA. Thus, the instruction converter 2312 represents software, firmware, hardware, or a combination thereof that, through emulation, simulation or any other process, allows a processor or other electronic device that does not have a first ISA processor or core to execute the first ISA binary code 2306.

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

### Examples

Illustrative examples of the technologies disclosed herein are provided below. An embodiment of the technologies may include any one or more, and any combination of, the examples described below.

Example 1 is an apparatus comprising a fully homomorphic encryption accelerator and a memory. The fully homomorphic encryption accelerator including a key generator circuit and a scratch pad memory. The key generator module to generate fully homomorphic encryption relinearization public keys from a seed. The fully homomorphic encryption relinearization public keys to be used by a plurality of compute elements to perform operations on polynomials. The key generator circuit comprising a plurality of key generator circuitry, each key generator circuitry to be loaded with the seed in response to a Key Generation seed instruction. The key generator circuitry comprising a random number generator to generate integer values and a sampler to receive the integer values from the random number generator and to randomly map an invalid integer value in an invalid range of invalid integer values to a valid integer value in a valid range of valid integer values. The scratch pad memory to store coefficients used by a plurality of compute elements to perform operations on polynomials. The memory to store data to be processed by the fully homomorphic encryption accelerator.

Example 2 includes the apparatus of Example 1, optionally the sampler to map the integer values generated by the random number generator from a number space of 0−(2ⁿ−1) to a ciphertext modulus space of 0−(q−1) by randomly mapping the invalid integer value generated by the random number generator that is greater than or equal to q to one of the valid integer values inside the valid range [0, q−1] using additional random bits.

Example 3 includes the apparatus of Example 2, optionally the fully homomorphic encryption accelerator further comprising a second random number generator loaded with a second seed, the second random number generator to generate the additional random bits.

Example 4 includes the apparatus of Example 1, optionally key generation operations are initiated in each key generator circuitry in response to a Key Generation start stop instruction.

Example 5 includes the apparatus of Example 1, optionally the key generator circuit comprises 16 key generator circuitry.

Example 6 includes the apparatus of Example 1, optionally each key generator circuitry includes a buffer to store valid integer values received from the sampler.

Example 7 includes the apparatus of Example 6, optionally the fully homomorphic encryption accelerator further comprises a compute engine control block, the compute engine control block is to include a Keygen valid vector, the Keygen valid vector including one bit for each key generator circuitry, a respective bit in the Keygen valid vector set to valid when the buffer in the key generator circuitry is full.

Example 8 includes the apparatus of Example 7, optionally in response to a Key Generation load instruction, if all bits in the keygen valid vector are valid, valid values stored in the buffer are output to a compute engine and all bits in the keygen valid vector are cleared.

Example 9 includes the apparatus of Example 8, optionally the buffers comprise FIFOs, the FIFOs to store 128 bytes of valid integer values.

Example 10 is a system comprising a processor core, a fully homomorphic encryption accelerator and a memory. The fully homomorphic encryption accelerator including a key generator circuit and a scratch pad memory. The key generator module to generate fully homomorphic encryption relinearization public keys from a seed. The fully homomorphic encryption relinearization public keys to be used by a plurality of compute elements to perform operations on polynomials. The key generator circuit comprising a plurality of key generator circuitry, each key generator circuitry to be loaded with the seed in response to a Key Generation seed instruction. The key generator circuitry comprising a random number generator to generate integer values and a sampler to receive the integer values from the random number generator and to randomly map an invalid integer value in an invalid range of invalid integer values to a valid integer value in a valid range of valid integer values. The scratch pad memory to store coefficients used by a plurality of compute elements to perform operations on polynomials. The memory to store data to be processed by the fully homomorphic encryption accelerator.

Example 11 includes the system of Example 10, optionally the sampler to map the integer values generated by the random number generator from a number space of 0−(2ⁿ−1) to a ciphertext modulus space of 0−(q−1) by randomly mapping the invalid integer value generated by the random number generator that is greater than or equal to q to one of the valid integer values inside the valid range [0, q−1] using additional random bits.

Example 12 includes the system of Example 11, optionally the fully homomorphic encryption accelerator further comprising a second random number generator loaded with a second seed, the second random number generator to generate the additional random bits.

Example 13 includes the system of Example 10, optionally key generation operations are initiated in each key generator circuitry in response to a Key Generation start stop instruction.

Example 14 includes the system of Example 10, optionally the key generator circuit comprises 16 key generator circuitry.

Example 15 includes the system of Example 10, optionally each key generator circuitry comprises a buffer to store valid integer values received from the sampler.

Example 16 is a method comprising generating, by a key generator circuit in a fully homomorphic encryption accelerator, fully homomorphic encryption relinearization public keys from a seed. The key generator circuit comprising a plurality of key generator circuitry. The method also includes using, by a plurality of compute elements, the fully homomorphic encryption relinearization public keys to perform operations on polynomials. The method also includes loading, each key generator circuitry with the seed in response to a Key Generation seed instruction, the key generator circuitry comprising a random number generator and a sampler. The method also includes receiving, by the sampler, integer values generated by the random number generator. The method also includes randomly mapping, by the sampler, an invalid integer value in an invalid range of invalid integer values to a valid integer value in a valid range of valid integer values. The method also includes storing, in a scratch pad memory in the fully homomorphic encryption accelerator, coefficients to be used by the plurality of compute elements to perform operations on polynomials. The method also includes storing, in a memory, data to be processed by the fully homomorphic encryption accelerator.

Example 17 includes the method of Example 16, optionally the sampler to map the integer values generated by the random number generator from a number space of 0−(2ⁿ−1) to a ciphertext modulus space of 0−(q−1) by randomly mapping the invalid integer value generated by the random number generator that is greater than or equal to q to one of the valid integer values inside the valid range [0, q−1] using additional random bits.

Example 18 includes the method of Example 17, optionally loading, a second random number generator with a second seed, the second random number generator to generate the additional random bits.

Example 19 includes the method of Example 16, optionally key generation operations are initiated in each key generator circuitry in response to a Key Generation start stop instruction.

Example 20 includes the method of Example 16, optionally each key generator circuitry comprises a buffer to store valid integer values received from the sampler.

Example 21 is at least one machine readable medium that includes a plurality of instructions that in response to being executed by a system can cause the system to carry out a method according to any one of examples 16 to 20.

Example 22 is an apparatus that includes means for performing the methods of any one of examples 16 to 20.

What is claimed is:

1. An apparatus comprising:
a fully homomorphic encryption accelerator comprising:
a key generator circuit to generate fully homomorphic encryption relinearization public keys from a seed, the fully homomorphic encryption relinearization public keys to be used by a plurality of compute elements to perform operations on polynomials, the key generator circuit comprising a plurality of key generator circuitry, each key generator circuitry to be loaded with the seed in response to a Key Generation seed instruction, the key generator circuitry comprising a random number generator to generate integer values and a sampler to receive the integer values from the random number generator and to randomly map an invalid integer value in an invalid range of invalid integer values to a valid integer value in a valid range of valid integer values; and
scratch pad memory to store coefficients used by a plurality of compute elements to perform operations on polynomials; and
memory to store data to be processed by the fully homomorphic encryption accelerator.

2. The apparatus of claim 1, wherein the sampler to map the integer values generated by the random number generator from a number space of 0−(2ⁿ−1) to a ciphertext modulus space of 0−(q−1) by randomly mapping the invalid integer value generated by the random number generator that is greater than or equal to q to one of the valid integer values inside the valid range [0, q−1] using additional random bits.

3. The apparatus of claim 2, wherein the fully homomorphic encryption accelerator further comprising:
a second random number generator loaded with a second seed, the second random number generator to generate the additional random bits.

4. The apparatus of claim 1, wherein key generation operations are initiated in each key generator circuitry in response to a Key Generation start stop instruction.

5. The apparatus of claim 1, wherein the key generator circuit comprises 16 key generator circuitry.

6. The apparatus of claim 1, wherein each key generator circuitry includes a buffer to store valid integer values received from the sampler.

7. The apparatus of claim 6, wherein the fully homomorphic encryption accelerator further comprises:
a compute engine control block, the compute engine control block is to include a Keygen valid vector, the Keygen valid vector including one bit for each key generator circuitry, a respective bit in the Keygen valid vector set to valid when the buffer in the key generator circuitry is full.

8. The apparatus of claim 7, wherein in response to a Key Generation load instruction, if all bits in the keygen valid vector are valid, valid values stored in the buffer are output to a compute engine and all bits in the keygen valid vector are cleared.

9. The apparatus of claim 8, wherein the buffers comprise FIFOs, the FIFOs to store 128 bytes of valid integer values.

10. A system comprising:
a processor core;
a fully homomorphic encryption accelerator comprising:
a key generator circuit to generate fully homomorphic encryption relinearization public keys from a seed, the fully homomorphic encryption relinearization public keys to be used by a plurality of compute elements to perform operations on polynomials, the key generator circuit comprising a plurality of key generator circuitry, each key generator circuitry to be loaded with the seed in response to a Key Generation seed instruction, the key generator circuitry comprising a random number generator to generate integer values and a sampler to receive the integer values from the random number generator and to randomly map an invalid integer value in an invalid range of invalid integer values to a valid integer value in a valid range of valid integer values; and
scratch pad memory to store coefficients used by a plurality of compute elements to perform operations on polynomials; and
memory to store data to be processed by the fully homomorphic encryption accelerator.

11. The system of claim 10, wherein the sampler to map the integer values generated by the random number generator from a number space of 0−(2ⁿ−1) to a ciphertext modulus space of 0−(q−1) by randomly mapping the invalid integer value generated by the random number generator that is greater than or equal to q to one of the valid integer values inside the valid range [0, q−1] using additional random bits.

12. The system of claim 11, wherein the fully homomorphic encryption accelerator further comprising:
a second random number generator loaded with a second seed, the second random number generator to generate the additional random bits.

13. The system of claim 10, wherein key generation operations are initiated in each key generator circuitry in response to a Key Generation start stop instruction.

14. The system of claim 10, wherein the key generator circuit comprises 16 key generator circuitry.

15. The system of claim 10, wherein each key generator circuitry comprises a buffer to store valid integer values received from the sampler.

16. A method comprising:
generating, by a key generator circuit in a fully homomorphic encryption accelerator, fully homomorphic encryption relinearization public keys from a seed, the key generator circuit comprising a plurality of key generator circuitry;
using, by a plurality of compute elements, the fully homomorphic encryption relinearization public keys to perform operations on polynomials;
loading, each key generator circuitry with the seed in response to a Key Generation seed instruction, the key generator circuitry comprising a random number generator and a sampler;
receiving, by the sampler, integer values generated by the random number generator;
randomly mapping, by the sampler, an invalid integer value in an invalid range of invalid integer values to a valid integer value in a valid range of valid integer values storing, in a scratch pad memory in the fully homomorphic encryption accelerator, coefficients to be used by the plurality of compute elements to perform operations on polynomials; and
storing, in a memory, data to be processed by the fully homomorphic encryption accelerator.

17. The method of claim 16, wherein the sampler to map the integer values generated by the random number generator from a number space of 0−(2ⁿ−1) to a ciphertext modulus space of 0−(q−1) by randomly mapping the invalid integer value generated by the random number generator that is greater than or equal to q to one of the valid integer values inside the valid range [0, q−1] using additional random bits.

18. The method of claim 17, further comprises:
loading, a second random number generator with a second seed, the second random number generator to generate the additional random bits.

19. The method of claim 16, wherein key generation operations are initiated in each key generator circuitry in response to a Key Generation start stop instruction.

20. The method of claim 16, wherein each key generator circuitry comprises a buffer to store valid integer values received from the sampler.
